(19) United States
(12) Patent Application Publication
(10) Pub. No.: US 2012/0068371 A1
(43) Pub. Date: Mar. 22, 2012

(54) PROCESSES FOR IMPROVED OPTICAL FILMS

(75) Inventors: William W. Merrill, White Bear Lake, MN (US); David D. Lindeman, Hudson, WI (US)

(73) Assignee: 3M Innovative Properties Company

(21) Appl. No.: 13/303,569

(22) Filed: Nov. 23, 2011

Related U.S. Application Data
(62) Division of application No. 11/539,335, filed on Oct. 6, 2006, now abandoned.

(51) Int. Cl. B29D 11/00

(52) U.S. Cl. 264/2.7

(57) ABSTRACT

A method of forming an optical film results in a film having a useful central 60% portion with a caliper variation of about 5% or less of an average thickness of the film. The method includes selecting a draw ratio λ in a first in-plane stretch direction, setting an effective draw gap defined by a length L and a width W, and stretching a polymer film at the draw ratio and effective draw gap. The effective draw gap is set such that the stretching step fits into one of two regimes, the first regime referred to as a uniaxial regime and characterized by a β equal to or less than about 1.0; and the second regime referred to as a planar extension regime and characterized by a β equal to or greater than about 10.0. The disclosure also describes an optical film formed by the method.

### CROSS REFERENCE TO RELATED APPLICATIONS

This application is a divisional application of U.S. patent application Ser. No. 11/539,335, filed on Oct. 6, 2006, now published as U.S. 2008/0085383, the disclosure of which is incorporated by reference in its entirety herein.

### TECHNICAL FIELD

This disclosure relates generally to optical films and methods for making optical films.

### BACKGROUND

Polymeric optical films are used in a wide variety of applications such as reflective polarizers. Such reflective polarizer films are used, for example, in conjunction with backlights in liquid crystal displays. A reflective polarizing film can be placed between the user and the backlight to recycle polarized light that would be otherwise absorbed, and thereby increasing brightness. These polymeric optical films often have high reflectivity, while being lightweight and resistant to breakage. Thus, the films are suited for use as reflectors and polarizers in compact electronic displays, such as liquid crystal displays (LCDs) placed in mobile telephones, personal data assistants, portable computers, desktop monitors, and televisions, for example.

In commercial processes, optical films made from polymeric materials or blends of materials are typically extruded from a die or cast from solvent. The extruded or cast film is then stretched to create and/or enhance birefringence in at least some of the materials. The materials and the stretching protocol may be selected to produce an optical film such as a reflective optical film, for example, a reflective polarizer or a mirror.

To reduce defects, such as die lines, and provide a film having a substantially uniform width, optical films such as reflective polarizing films, have been extruded from relatively narrow dies and then stretched in a crossweb or film width direction (referred to herein as the transverse direction or TD). Usually, such reflective polarizing films have a block axis along the TD.

In some applications, it is advantageous to laminate a reflective polarizing film to a dichroic polarizing film to make, for example, a film construction for a liquid crystal display (LCD). When supplied in roll form, the dichroic polarizing film usually has a block axis along the length of the roll (MD). The block axis in the dichroic polarizing film and the reflective polarizing film discussed above are perpendicular to one another. To make the laminate film construction for an optical display, the reflective polarizing film must first be cut into sheets, rotated 90°, and then laminated to the dichroic polarizing film. This laborious process makes it difficult to produce laminated film constructions in roll form on a commercial scale and increases the cost of the final product.

Thus, there is a need for a process for making a reflective optical film that is oriented in the MD. In one embodiment, the process results in a reflective polarizing film.

### SUMMARY

A method of forming an optical film results in a film having a useful central 60% portion with a caliper variation of about 5% or less of an average thickness of the film. The method includes selecting a draw ratio λ in a first in-plane stretch direction, setting an effective draw gap defined by a length L and a width W, and stretching a polymer film at the draw ratio and effective draw gap. The effective draw gap is set such that the stretching step fits into one of two regimes, the first regime referred to as a uniaxial regime and characterized by a β equal to or less than about 1.0; and the second regime referred to as a planar extension regime and characterized by a β equal to or greater than about 10.0. The disclosure also describes an optical film formed by the method.

The above summary is not intended to describe each illustrated embodiment or every implementation of the present invention. The figures and the detailed description which follow more particularly exemplify these embodiments.

### BRIEF DESCRIPTION OF THE DRAWINGS

The invention may be more completely understood in consideration of the following detailed description of various embodiments of the invention in connection with the accompanying drawings, in which:

FIGS. 1A and 1B illustrate optical films.

FIG. 2 illustrates a blended optical film.

FIG. 3A is a schematic diagram of a film line using a length orienter.

FIG. 3B is a schematic diagram of another embodiment of a film line using a length orienter.

FIG. 3C is a schematic diagram of one embodiment of a length orienter threading system.

FIG. 3D is a schematic diagram of another embodiment of a length orienter threading system.

FIG. 4 is a schematic illustration of the deformation of a unit of film in an uniaxial regime.

FIG. 5 is a schematic illustration of the deformation of a unit of film in a planar extension regime.

FIG. 6 illustrates the crossweb thickness profile for a series of model films with various L/W aspect ratios, of initially uniform 0.030″ (0.76 mm) thickness drawn to approximately five times in MD.

FIG. 7 illustrates the crossweb thickness profiles for the films of FIG. 6, normalized by their respective center values and plotted versus their total normalized final crossweb positions.

FIG. 8 illustrates the crossweb thickness profile for a series of model films with various L/W aspect ratios, of initially uniform 0.030″ (0.76 mm) thickness drawn to approximately 3.25 times in MD.

FIG. 9 illustrates the crossweb thickness profile normalized by compensating the aspect ratio with the draw ratio.

FIG. 10 illustrates the crossweb TD draw profile for a series of model films with various L/W aspect ratios, of initially uniform 0.030″ (0.76 mm) thickness drawn to approximately five times in MD.

FIG. 11 illustrates the variation of TD draw profile with varying MD draw ratios at an aspect ratio of 0.4.

FIG. 12 illustrates the variation of TD draw profile with varying MD draw ratios at an aspect ratio of 1.6.

FIG. 13A shows the approximate progress of the draw ratio with MD position in accord with a model simulation.

FIG. 13B graphically illustrates a method for finding equivalent conditions of pairs of draw ratio (MDDR) and gap/film aspect ratio (L/W), using the draw ratio development along the gap.

FIG. 14 shows the rate of change of Hencky strain with MD progress in accord with the model of FIG. 13A.

FIG. 15 illustrates normalized crossweb thickness profiles showing a general set of roughly equivalent conditions.

FIG. 16 illustrates the effects of material stiffness on MD Hencky strain behavior.

FIG. 17 illustrates the effects of material stiffness on TD Hencky strain behavior.

FIG. 18 illustrates the extents of truly uniaxial character as determined by the model draw ratios for groups similar to the cases in FIG. 15.

FIG. 19 illustrates a laminate construction in which a first optical film is attached to a second optical film.

FIGS. 20A-20B are cross-sectional views of exemplary constructions made according to the present disclosure.

FIGS. 21A-21C are cross-sectional views of exemplary constructions made according to the present disclosure.

FIG. 22 is a cross-sectional view of an exemplary construction made according to the present disclosure.

FIG. 23 is a graph illustrating theoretical modeling results and experimental results for various MD draw ratios.

FIG. 24 is a graph illustrating the uniaxial character for exemplary films.

FIG. 25 is a representative temperature profile.

### DETAILED DESCRIPTION

The present disclosure is directed to making optical films. Optical films differ from other films, for example, in that they are required to have uniformity and sufficient optical quality designed for a particular end use application, for example, optical displays. For the purposes of this application, sufficient quality for use in optical displays means that the films, when mounted in the desired application, following all processing steps, are substantially free of visible defects, e.g., have substantially no color streaks or surface ridges running in the MD when viewed by an unaided human eye when mounted or integrated in an optical application. In addition, an exemplary embodiment of an optical quality film of the present disclosure has a caliper variation over the useful film area of about 5% (+/−2.5%) or less, preferably about 3.5% (+/−1.75%) or less, or about 3% (+/−1.5%) or less, and more preferably about 1% (+/−0.5%) or less of the average thickness of the film.

In one embodiment of the present disclosure, a process used to make reflective polarizing films uses a die constructed to make an extruded film that is then stretched along the downweb direction in a length orienter (LO), which is an arrangement of rollers rotating at differing speeds selected to stretch the film along the film length direction, which also may be referred to as the machine direction (MD). In one embodiment, a film produced using an LO, which may be a reflective polarizing film, has a block axis (i.e., the axis characterized by a lower transmission of light polarized along that direction than that polarized along an orthogonal direction) typically approximately aligned within about 10 degrees, and preferably approximately aligned within about 5 degrees, of the MD. In another embodiment, the film, which may be a reflective polarizing film, has a block axis typically approximately aligned within about 10 degrees, and preferably approximately aligned within about 5 degrees, of the TD.

The present disclosure is directed to methods for making optical films, such as reflective polarizing films having a polarizing axis along their length (along the MD), multilayer reflective mirror films, or compensator films, for example. The reflective polarizing films may include, without limitation, multilayer reflective polarizing films and diffusely reflective polarizing optical films. In some exemplary embodiments, the reflective polarizing films may be advantageously laminated to other optical films in roll-to-roll processes. In the context of the present disclosure, a reflective polarizer preferentially reflects light of a first polarization and preferentially transmits light of a second, different polarization. Preferably, a reflective polarizer reflects a majority of light of a first polarization and transmits a majority of light of a second, different polarization.

The following description should be read with reference to the drawings, in which like elements in different drawings are numbered in like fashion. The drawings, which are not necessarily to scale, depict selected illustrative embodiments and are not intended to limit the scope of the disclosure. Although examples of construction, dimensions, and materials are illustrated for the various elements, those skilled in the art will recognize that many of the examples provided have suitable alternatives that may be utilized.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein.

The recitation of numerical ranges by endpoints includes all numbers subsumed within that range (e.g. 1 to 5 includes 1, 1.5, 2, 2.75, 3, 3.80, 4, and 5) and any range within that range.

As used in this specification and the appended claims, the singular forms “a,” “an,” and “the” encompass embodiments having plural referents, unless the content clearly dictates otherwise. For example, reference to “a film” encompasses embodiments having one, two or more films. As used in this specification and the appended claims, the term “or” is generally employed in its sense including “and/or” unless the content clearly dictates otherwise.

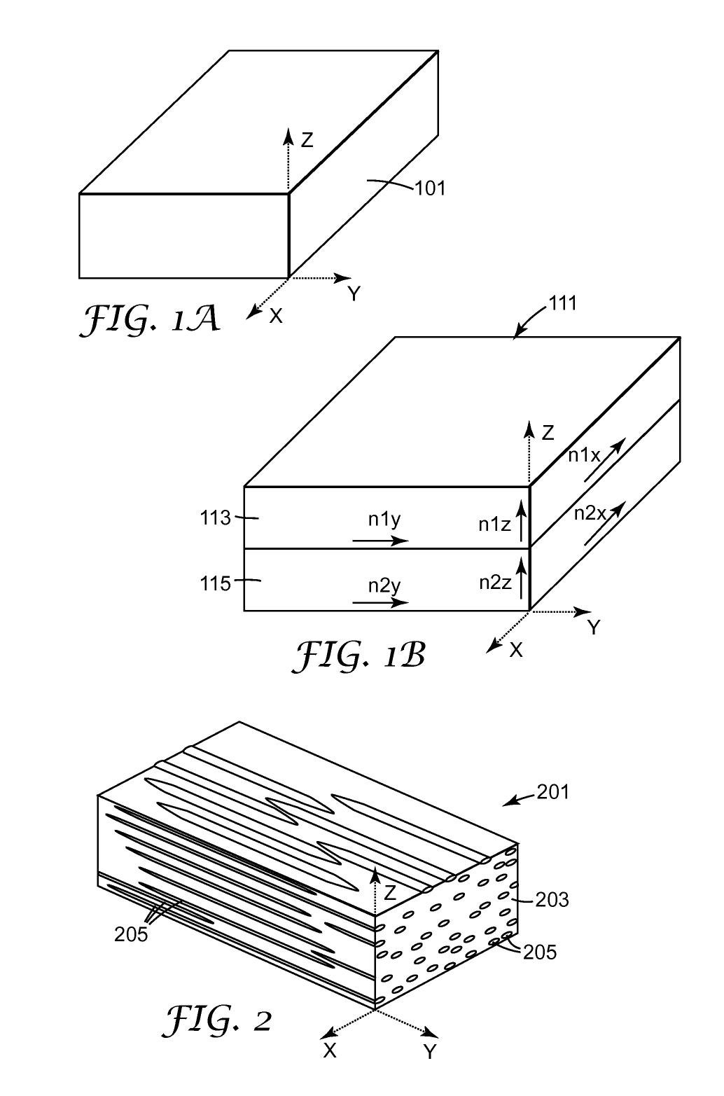

FIG. 1A illustrates a portion of an optical film construction 101 that may be formed in the processes described below. The depicted optical film 101 may be described with reference to three mutually orthogonal axes x, y and z. In the illustrated embodiment, two orthogonal axes x and y are in the plane of the film 101 (in-plane, or x and y axes) and a third axis (z-axis) extends in the direction of the film thickness. In some exemplary embodiments, the optical film 101 includes at least two different materials, a first material and a second material, which are optically interfaced (e.g., two materials combine to cause an optical effect such as reflection, scattering, transmission, etc.). In some instances, the materials are arranged in alternating layers. In other instances, the materials form interdispersed phases (eg. one continuous phase and another phase dispersed in that continuous matrix; or two bi-continuous phases) within a monolithic layer of the blended materials.

In typical embodiments of the present disclosure, one or both materials are polymeric. The first and second materials may be selected to produce a desired mismatch of refractive indices in a direction along at least one axis of the film 101. The materials may also be selected to produce a desired match of refractive indices in a direction along at least one axis of the film 101 perpendicular to a direction along which the refractive indices are mismatched. At least one of the materials is subject to developing birefringence under certain conditions. The materials used in the optical film are preferably selected to have sufficiently similar rheology (e.g., visco-elasticity) to meet the requirements of a coextrusion process, although cast films can also be used. In other exemplary embodiments, the optical film 101 may be composed of only one material or a miscible blend of two or more materials.

The optical film 101 can be a result of a film processing method that may include drawing or stretching the film. Drawing a film under different processing conditions may result in widening of the film without strain-induced orientation, widening of the film with strain-induced orientation, or strain-induced orientation of the film with lengthening. Strain can also be introduced by a compression step, such as by calendering. Generally, the forming process can include either type of orientation (extension or compression-type) or it can include both; one embodiment includes a step imparting both compression and extension simultaneously. The induced molecular orientation may be used, for example, to change the refractive index of an affected material in the direction of the draw. The amount of molecular orientation induced by the draw can be controlled based on the desired properties of the film, as described more fully below.

The term “birefringent” means that the indices of refraction in orthogonal x, y, and z directions are not all the same. For the polymer layers described herein, the axes are selected so that x and y axes are in the plane of the layer and the z axis corresponds to the thickness or height of the layer. The principal axes refer to the directions where the indices of refraction are at the maximum and minimum values. The term “in-plane birefringence” is understood to be the difference between the principal in-plane indices (nₓ and n_{y}) of refraction. The term “out-of-plane birefringence” is understood to be the difference between one of the principal in-plane indices (nₓ or n_{y}) of refraction and the principal out-of-plane index of refraction n_{z}.

It is useful to compare the relative differences between the smallest out-of-plane birefringence as would be related to the various pass state matching conditions at various angles of incidence and the in-plane birefringence to assess the relative optical power of a multi-layer polarizer at normal incidence versus its color non-uniformity or pass state reflection at off-normal axis. The term “relative birefringence” is understood to be approximately the ratio of the smallest out-of-plane birefringence to the in-plane birefringence. More precisely, the relative birefringence is calculated as the ratio of the absolute value of the smallest out-of-plane birefringence determined by the out-of-plane refractive index n_{z} and the in-plane principal index of refraction nearest to it in value, to the absolute value of the difference between the average of this out-of-plane refractive index n_{z} and the in-plane principal index of refraction nearest to it in value and the other in-plane principal refractive index. The principal in-plane directions typically align in approximately the crossweb/transverse direction (TD) and the downweb/machine direction (MD), especially in the center of the film in a cross-web symmetric process. The principal out-of-plane direction may approximate the normal direction (ND). For example, if the draw is principally along the x direction, then near the center of the film in the cross-web direction, the relative birefringence is calculated as |n_{y}−n_{z}| divided by |nₓ−(n_{y}+n_{z})/2|. Useful values of relative birefringence are typically between 0.10 and 0.20, although lower values may also be desired. All birefringence and index of refraction values are reported for 632.8 nm light unless otherwise indicated.

A birefringent, oriented layer typically exhibits a difference between the transmission and/or reflection of incident light rays having a plane of polarization parallel to the oriented direction (i.e., stretch direction) and light rays having a plane of polarization parallel to a transverse direction (i.e., a direction orthogonal to the stretch direction). For example, when an orientable polyester film is stretched along the x axis, the typical result is that nₓ≠n_{y}, where nₓ and n_{y} are the indices of refraction for light polarized in a plane parallel to the “x” and “y” axes, respectively. The degree of alteration in the index of refraction along the stretch direction will depend on factors such as the amount of stretching, the stretch rate, the temperature of the film during stretching, the thickness of the film, the variation in the film thickness, and the composition of the film.

It will be appreciated that the refractive index in a material is a function of wavelength (i.e., materials typically exhibit dispersion). Therefore, the optical requirements on refractive index are also a function of wavelength. The index ratio of two optically interfaced materials can be used to calculate the reflective power of the two materials. The absolute value of the refractive index difference between the two materials for light polarized along a particular direction divided by the average refractive index of those materials for light polarized along the same direction is descriptive of the film's optical performance. This will be called the normalized refractive index difference.

In a reflective polarizer, it is generally desirable that the normalized difference, if any, in mismatched in-plane refractive indices, e.g., in-plane (MD) direction, be at least about 0.06, more preferably at least about 0.09, and even more preferably at least about 0.11 or more. More generally, it is desirable to have this difference as large as possible without significantly degrading other aspects of the optical film. It is also generally desirable that the normalized difference, if any, in matched in-plane refractive indices, e.g., in the in-plane (TD) direction, be less than about 0.06, more preferably less than about 0.03, and most preferably less than about 0.01. Similarly, it can be desirable that any normalized difference in refractive indices in the thickness direction of a polarizing film, e.g., in the out-of-plane (ND) direction, be less than about 0.11, less than about 0.09, less than about 0.06, more preferably less than about 0.03, and most preferably less than about 0.01. In certain instances it may desirable to have a controlled mismatch in the thickness direction of two adjacent materials in a multilayer stack. The influence of the z-axis refractive indices of two materials in a multilayer film on the optical performance of such a film are described more fully in U.S. Pat. No. 5,882,774, entitled Optical Film; U.S. Pat. No. 6,531,230, entitled “Color Shifting Film;” and U.S. Pat. No. 6,157,490, entitled “Optical Film with Sharpened Bandedge,” the contents of which are incorporated herein by reference.

Exemplary embodiments of the present disclosure also may be characterized by “an effective orientation axis,” which is the in-plane direction in which the refractive index has changed the most as a result of strain-induced orientation. For example, the effective orientation axis typically coincides with the block axis of a polarizing film, reflective or absorbing. In general, there are two principal axes for the in-plane refractive indices, which correspond to maximum and minimum refractive index values. For a positively birefringent material, in which the refractive index tends to increase for light polarized along the main axis or direction of stretching, the effective orientation axis coincides with the axis of maximum in-plane refractive index. For a negatively birefringent material, in which the refractive index tends to decrease for light polarized along the main axis or direction of stretching, the effective orientation axis coincides with the axis of minimum in-plane refractive index.

The optical film 101 is typically formed using two or more different materials. In some exemplary embodiments, the optical film of the present disclosure includes only one birefringent material. In other exemplary embodiments, the optical film of the present disclosure includes at least one birefringent material and at least one isotropic material. In yet other exemplary embodiments, the optical film includes a first birefringent material and a second birefringent material. In some such exemplary embodiments, the in-plane refractive indices of both materials change similarly in response to the same process conditions. In one embodiment, when the film is drawn, the refractive indices of the first and second materials should both increase for light polarized along the direction of the draw (e.g., the MD) while decreasing for light polarized along a direction orthogonal to the stretch direction (e.g., the TD). In another embodiment, when the film is drawn, the refractive indices of the first and second materials should both decrease for light polarized along the direction of the draw (e.g., the MD) while increasing for light polarized along a direction orthogonal to the stretch direction (e.g., the TD). In some embodiments, where one, two or more birefringent materials are used in an oriented optical film according to the present disclosure, the effective orientation axis of each birefringent material is aligned approximately along the MD.

In some cases, the optical film is especially suited for use as a mirror film, which may not have an effective orientation axis. In other cases, when the orientation resulting from a combination of process steps causes a match of the refractive indices of the two materials in one in-plane direction and a substantial mismatch of the refractive indices in the other in-plane direction, the film is especially suited for fabricating an optical polarizer. The matched direction forms a transmission (pass) direction for the polarizer and the mismatched direction forms a reflection (block) direction. Generally, the larger the mismatch in refractive indices in the reflection direction and the closer the match in the transmission direction, the better the performance of the polarizer.

One class of polymers useful in creating polarizer films is polyesters. One example of a polyester-based polarizer includes a stack of polyester layers of differing compositions. One configuration of this stack of layers includes a first set of birefringent layers and a second set of layers with an isotropic index of refraction. The second set of layers alternates with the birefringent layers to form a series of interfaces for reflecting light.

The properties of a given polyester are typically determined by the monomer materials utilized in the preparation of the polyester. A polyester is often prepared by reactions of one or more different carboxylate monomers (e.g., compounds with two or more carboxylic acid or ester functional groups) with one or more different glycol monomers (e.g., compounds with two or more hydroxy functional groups). Each set of polyester layers in the stack typically has a different combination of monomers to generate the desired properties for each type of layer. In many embodiments, the multilayer reflective polarizers are formed from polymer layers made from polyesters having naphthalate subunits, including, for example, homopolymers or copolymers of polyethylene naphthalate. In other embodiments, the multilayer reflective polarizers are formed from polymer layers made from polyesters having terephthalate subunits, including, for example, homopolymers or copolymers of polyethylene terephthalate. In still other embodiments, the multilayer reflective polarizers are formed from polymer layers made from polyesters having both naphthalate and terephthalate subunits with mol % s x and y respectively. These copolymers are henceforth referred to as x/y coPENs.

FIG. 1B illustrates a multilayer optical film 111 that includes a first layer of a first material 113 disposed (e.g., by coextrusion) on a second layer of a second material 115. Either or both of the first and second materials may be positively or negatively birefringent. While only two layers are illustrated in FIG. 1B and generally described herein, the process is applicable to multilayer optical films having up to hundreds or thousands or more of layers made from any number of different materials. The multilayer optical film 111 or the optical film 101 may include additional layers. The additional layers may be optical, e.g., performing an additional optical function, or non-optical, e.g., selected for their mechanical or chemical properties, or both. As discussed in U.S. Pat. No. 6,179,948, incorporated herein by reference, these additional layers may be orientable under the process conditions described herein, and may contribute to the overall optical and/or mechanical properties of the film.

The optical layers 113, 115 and, optionally, one or more of the non-optical layers are typically placed one on top of the other to form a stack of layers, as shown in FIG. 1B. The optical layers 113, 115 are arranged as alternating optical layer pairs where each optical layer pair includes a first polymer layer 113 and a second polymer layer 115, as shown in FIG. 1B, to form a series of interfaces between layers with different optical properties. The interface between the two different optical layers (e.g., first and second layers) forms a light reflection plane if the indices of refraction of the first and second polymer layers are different in at least one direction, e.g., at least one of x, y, and z directions.

Light polarized in a plane parallel to the direction in which the indices of refraction of the two layers are approximately equal will be substantially transmitted. Light polarized in a plane parallel to the direction in which the two layers have different indices will be at least partially reflected. The reflectivity can be increased by increasing the number of layers or by increasing the difference in the indices of refraction between the first and second layers. Generally, multilayer optical films can have 2 to 5000 optical layers, or 25 to 2000 optical layers, or 50 to 1500 optical layers, or 75 to 1000 optical layers. A film having a plurality of layers can include layers with different optical thicknesses to increase the reflectivity of the film over a range of wavelengths. For example, a film can include pairs of layers that are individually tuned (for normally incident light, for example) to achieve optimal reflection of light having particular wavelengths. It should further be appreciated that, although only a single multilayer stack may be described, the multilayer optical film can be made from multiple stacks that are subsequently combined to form the film. Other considerations relevant to making multilayer reflective polarizers are described, for example, in U.S. Pat. No. 5,882,774 to Jonza et al., the disclosure of which is hereby incorporated by reference herein to the extent it is not inconsistent with the present disclosure.

In many embodiments, the optical films are thin. Suitable films include films of various thickness and particularly include films less than 15 mils (about 380 micrometers) thick, or less than 10 mils (about 250 micrometers) thick, or less than 7 mils (about 180 micrometers) thick, or less than 2 mils (about 51 micrometers) thick.

To produce a mirror film, for example, it is generally desirable that the refractive indices are mismatched in both the in-plane principal transverse direction (TD) and the in-plane principal machine direction (MD). To produce a reflective polarizer, for example, it is generally desirable that the difference if any, in the matched refractive indices, e.g., in the in-plane principal transverse direction (TD), be less than about 0.05, more preferably less than about 0.02, and most preferably less than about 0.01. In the mismatched direction e.g., in-plane principal machine direction (MD), it is generally desirable that the difference in refractive indices be at least about 0.06, more preferably greater than about 0.09, and even more preferably greater than about 0.11. More generally, it is desirable to have this difference as large as possible without significantly degrading other aspects of the optical film.

One approach to forming a reflective polarizer uses a first material that becomes birefringent as a result of processing according to the present disclosure and a second material having an index of refraction which remains substantially isotropic, i.e., does not develop appreciable amounts of birefringence, during the draw process. In some exemplary embodiments, the second material is selected to have a refractive index which matches the non-drawn in-plane refractive index of the first material subsequent to the draw.

Optical power may be exhibited over a range of any spectral band, e.g. infrared, ultraviolet or visible, for example. In many embodiments, the multilayer optical film exhibits an optical power in a band range, eg. from 500 to 800 nm or from 600 to 700 nm, for example. The optical power may be calculated with respect to a fixed band range or with respect to a relative band range as set forth by the internal layer structure of the optical film. When a relative band edge is chosen, one may choose the 50% transmission band edge, i.e. where 50% of the light is transmitted. Optical power can then be calculated by taking dark state on-axis transmission measurements (% T) (with a spectrophotometer such as, for example a Lambda 19 spectrophotometer) between the 50% transmission band edges and converting it to optical density (OD) units by the following equation:

OD=−LOG [% T/100]

The area under this OD unit curve is optical power.

For a polarizer embodiment in which the indices of two polymer layers are matched in the non-stretched in-plane direction and not matched in the stretched direction, optical power is a measure proportional to the refractive index difference between the first polymer layer material and the second polymer layer material, in the stretch direction. Since the effective refractive index difference between the first polymer layer material and the second polymer layer material may not be easy to measure, optical power calculations are a convenient means to determine the birefringence between layers in multilayer optical films, provided the number of layer pairs, and materials used are known. Optical power is proportional to the number of optical layer pairs in a specific multilayer optical film; thus, optical power of a specific film can be divided by the number of optical layer pairs to obtain an (average) optical power per optical layer pair. In many embodiments, the multilayer optical films have an optical power in a range from 1.2 to 2.0 per optical layer pair, or from 1.4 to 1.7 per optical layer pair. Thus, one illustrative multilayer optical film having 825 layers or about 411 layer pairs have an optical power in a range from 500 to 800, or from 600 to 700.

Materials suitable for use in the optical films of FIGS. 1A, 1B are discussed in, for example, U.S. Pat. No. 5,882,774, which is incorporated herein by reference. Suitable materials include polymers such as, for example, polyesters, copolyesters and modified copolyesters. In this context, the term “polymer” will be understood to include homopolymers and copolymers, as well as polymers or copolymers that may be formed in a miscible blend, for example, by co-extrusion or by reaction, including, for example, transesterification. The terms “polymer” and “copolymer” include both random and block copolymers. Polyesters suitable for use in some exemplary optical films of the optical bodies constructed according to the present disclosure generally include carboxylate and glycol subunits and can be generated by reactions of carboxylate monomer molecules with glycol monomer molecules. Each carboxylate monomer molecule has two or more carboxylic acid or ester functional groups and each glycol monomer molecule has two or more hydroxy functional groups. The carboxylate monomer molecules may all be the same or there may be two or more different types of molecules. The same applies to the glycol monomer molecules. Also included within the term “polyester” are polycarbonates derived from the reaction of glycol monomer molecules with esters of carbonic acid.

Suitable carboxylate monomer molecules for use in forming the carboxylate subunits of the polyester layers include, for example, 2,6-naphthalene dicarboxylic acid and isomers thereof; terephthalic acid; isophthalic acid; phthalic acid; azelaic acid; adipic acid; sebacic acid; norbornene dicarboxylic acid; bi-cyclooctane dicarboxylic acid; 1,6-cyclohexane dicarboxylic acid and isomers thereof; t-butyl isophthalic acid, trimellitic acid, sodium sulfonated isophthalic acid; 4,4′-biphenyl dicarboxylic acid and isomers thereof; and lower alkyl esters of these acids, such as methyl or ethyl esters. The term “lower alkyl” refers, in this context, to C1-C10 straight-chained or branched alkyl groups.

Suitable glycol monomer molecules for use in forming glycol subunits of the polyester layers include ethylene glycol; propylene glycol; 1,4-butanediol and isomers thereof; 1,6-hexanediol; neopentyl glycol; polyethylene glycol; diethylene glycol; tricyclodecanediol; 1,4-cyclohexanedimethanol and isomers thereof; norbornanediol; bicyclo-octanediol; trimethylol propane; pentaerythritol; 1,4-benzenedimethanol and isomers thereof; bisphenol A; 1,8-dihydroxy biphenyl and isomers thereof; and 1,3-bis(2-hydroxyethoxy)benzene.

An exemplary polymer useful in the optical films of the present disclosure is polyethylene naphthalate (PEN), which can be made, for example, by reaction of naphthalene dicarboxylic acid with ethylene glycol. Polyethylene 2,6-naphthalate (PEN) is frequently chosen as a first polymer. PEN has a large positive stress optical coefficient, retains birefringence effectively after stretching, and has little or no absorbance within the visible range. PEN also has a large index of refraction in the isotropic state. Its refractive index for polarized incident light of 550 nm wavelength increases when the plane of polarization is parallel to the stretch direction from about 1.64 to as high as about 1.9. Increasing molecular orientation increases the birefringence of PEN. The molecular orientation may be increased by stretching the material to greater stretch ratios and holding other stretching conditions fixed. Other semicrystalline polyesters suitable as first polymers include, for example, polybutylene 2,6-naphthalate (PBN), polyhexamethylene naphthalate (PHN), polyethylene terephthalate (PET), polybutylene terephthalate (PBT), polyhexamethylene terephthalate (PHT), and copolymers thereof, e.g. the various x/y coPENs, etc.

In an exemplary embodiment, a second polymer of the second optical layers is chosen so that in the finished film, the refractive index, in at least one direction, differs significantly from the index of refraction of the first polymer in the same direction. Because polymeric materials are typically dispersive, that is, their refractive indices vary with wavelength, these conditions should be considered in terms of a particular spectral bandwidth of interest. It will be understood from the foregoing discussion that the choice of a second polymer is dependent not only on the intended application of the multilayer optical film in question, but also on the choice made for the first polymer, as well as processing conditions.

Other materials suitable for use in optical films and, particularly, as a first polymer of the first optical layers, are described, for example, in U.S. Pat. Nos. 6,352,761, 6,352,762 and 6,498,683 and U.S. patent application Ser. No. 09/229,724 and 09/399,531, which are incorporated herein by reference. Another polyester that is useful as a first polymer is a coPEN having carboxylate subunits derived from 90 mol % dimethyl naphthalene dicarboxylate and 10 mol % dimethyl terephthalate and glycol subunits derived from 100 mol % ethylene glycol subunits and an intrinsic viscosity (IV) of 0.48 dL/g. The index of refraction of that polymer is approximately 1.63. The polymer is herein referred to as low melt PEN (90/10). Another useful first polymer is a PET having an intrinsic viscosity of 0.74 dL/g, available from Eastman Chemical Company (Kingsport, Tenn.). Non-polyester polymers are also useful in creating polarizer films. For example, polyether imides can be used with polyesters, such as PEN and coPEN, to generate a multilayer reflective mirror. Other polyester/non-polyester combinations, such as polyethylene terephthalate and polyethylene (e.g., those available under the trade designation Engage 8200 from Dow Chemical Corp., Midland, Mich.), can be used.

The second optical layers can be made from a variety of polymers having glass transition temperatures compatible with that of the first polymer and having a refractive index similar to one refractive index plane of the first polymer. Examples of other polymers suitable for use in optical films, and particularly in the second optical layers or minor phases in blended optical films, include vinyl polymers and copolymers made from monomers such as vinyl naphthalenes, styrene, styrene acrylonitrile, maleic anhydride, acrylates, and methacrylates. Examples of such polymers include polyacrylates, polymethacrylates, such as poly (methyl methacrylate) (PMMA), and isotactic or syndiotactic polystyrene. Other polymers include condensation polymers such as polysulfones, polyamides, polyurethanes, polyamic acids, and polyimides. In addition, the second optical layers can be formed from polymers or copolymers of, or blends of copolyesters and polycarbonates such as, SA115 from Eastman, Xylex from GE, or Makroblend from Bayer.

Other exemplary suitable polymers, especially for use in the second optical layers, include homopolymers of polymethylmethacrylate (PMMA), such as those available from Ineos Acrylics, Inc., Wilmington, Del., under the trade designations CP71 and CP80, or polyethyl methacrylate (PEMA), which has a lower glass transition temperature than PMMA. Additional second polymers include copolymers of PMMA (coPMMA), such as a coPMMA made from 75 wt % methylmethacrylate (MMA) monomers and 25 wt % ethyl acrylate (EA) monomers, (available from Ineos Acrylics, Inc., under the trade designation Perspex CP63), a coPMMA formed with MMA comonomer units and n-butyl methacrylate (nBMA) comonomer units, or a blend of PMMA and poly(vinylidene fluoride) (PVDF) such as that available from Solvay Polymers, Inc., Houston, Tex. under the trade designation Solef 1008. Additional copolymers useful as second optical layers or minor phases in blends include styrene acrylate copolymers such as NAS30 from Noveon and MS600 from Sanyo Chemicals.

Yet other suitable polymers, especially for use in the second optical layers, include polyolefin copolymers such as poly (ethylene-co-octene) (PE-PO) available from Dow-Dupont Elastomers under the trade designation Engage 8200, poly (propylene-co-ethylene) (PPPE) available from Fina Oil and Chemical Co., Dallas, Tex., under the trade designation Z9470, and a copolymer of atatctic polypropylene (aPP) and isotatctic polypropylene (iPP) available from Huntsman Chemical Corp., Salt Lake City, Utah, under the trade designation Rexflex W111. The optical films can also include, for example in the second optical layers, a functionalized polyolefin, such as linear low density polyethylene-g-maleic anhydride (LLDPE-g-MA) such as that available from E.I. duPont de Nemours & Co., Inc., Wilmington, Del., under the trade designation Bynel 4105.

Exemplary combinations of materials in the case of polarizers include PEN/co-PEN, polyethylene terephthalate (PET)/co-PEN, PEN/sPS, PEN/Eastar, and PET/Eastar, where “co-PEN” refers to a copolymer or blend based upon naphthalene dicarboxylic acid (as described above) and Eastar is polycyclohexanedimethylene terephthalate commercially available from Eastman Chemical Co. Exemplary combinations of materials in the case of mirrors include PET/coPMMA, PEN/PMMA or PEN/coPMMA, PET/ECDEL, PEN/ECDEL, PEN/sPS, PEN/THV, PEN/co-PET, and PET/coPMMA, where “co-PET” refers to a copolymer or blend based upon terephthalic acid (as described above), ECDEL is a thermoplastic polyester commercially available from Eastman Chemical Co., and THV is a fluoropolymer commercially available from 3M Company. PMMA refers to polymethyl methacrylate and PETG refers to a copolymer of PET employing a second glycol comonomer (cyclohexanedimethanol). sPS refers to syndiotactic polystyrene. The film may optionally be treated by applying any or all of corona treatments, primer coatings or drying steps in any order to enhance its surface properties for subsequent lamination steps.

In another embodiment, the optical film can be or can include a reflective polarizer that is a blend optical film. In a typical blend film, a blend (or mixture) of at least two different materials is used. A mismatch in refractive indices of the two or more materials along a particular axis can be used to cause incident light that is polarized along that axis to be substantially scattered, resulting in a significant amount of diffuse reflection of that light. Incident light that is polarized in the direction of an axis in which the refractive indices of the two or more materials are matched will be substantially transmitted or at least transmitted with a much lesser degree of scattering. By controlling the relative refractive indices of the materials, among other properties of the optical film, a diffusely reflective polarizer may be constructed. Such blend films may assume a number of different forms. For example, the blend optical film may include one or more disperse phases within one or more continuous phases, or co-continuous phases. The general formation and optical properties of various blend films are further discussed in U.S. Pat. Nos. 5,825,543 and 6,111,696, the disclosures of which are incorporated by reference herein.

FIG. 2 illustrates an embodiment of the present disclosure formed of a blend of a first material and a second material that is substantially immiscible in the first material. In FIG. 2, an optical film 201 is formed of a continuous (matrix) phase 203 and a disperse (discontinuous) phase 207. The continuous phase may comprise the first material and the second phase may comprise the second material. The optical properties of the film may be used to form a diffusely reflective polarizing film. In such a film, the refractive indices of the continuous and disperse phase materials are substantially matched along one in-plane axis and are substantially mismatched along another in-plane axis. Generally, one or both of the materials are capable of becoming positively birefringent as a result of calendering or stretching under the appropriate conditions. In the diffusely reflective polarizer, such as that shown in FIG. 2, it is desirable to match the refractive indices of the materials in the direction of one in-plane axis of the film as close as possible while having as large of a refractive indices mismatch as possible in the direction of the other in-plane axis.

If the optical film 201 is a blend film including a disperse phase 205 and a continuous phase 203 as shown in FIG. 2 or a blend film including a first co-continuous phase and a second co-continuous phase, many different materials may be used as the continuous or disperse phases. Such materials may include inorganic materials such as silica-based polymers, organic materials such as liquid crystals, and polymeric materials, including monomers, copolymers, grafted polymers, and mixtures or blends thereof. The materials selected for use as the continuous and disperse phases or as co-continuous phases in the blend optical film having the properties of a diffusely reflective polarizer may, in some exemplary embodiments, include at least one optical material that is orientable under the processing conditions to introduce birefringence and at least one material that does not appreciably orient under the processing conditions and does not develop an appreciable amount of birefringence. Other exemplary materials useful as the minor or disperse phase in a blended optical film include negatively birefringent polymers such as syndiotactic polystyrene (sPS) and syndiotactic polyvinyl naphthalene.

Details regarding materials selection for blend films are set forth in U.S. Pat. Nos. 5,825,543 and 6,590,705, both incorporated by reference. Suitable materials for the continuous phase (which also may used in the disperse phase in certain constructions or in a co-continuous phase) may be amorphous, semicrystalline, or crystalline polymeric materials, including materials made from monomers based on carboxylic acids such as isophthalic, azelaic, adipic, sebacic, dibenzoic, terephthalic, 2,7-naphthalene dicarboxylic, 2,6-naphthalene dicarboxylic, cyclohexanedicarboxylic, and bibenzoic acids (including 4,4′-bibenzoic acid), or materials made from the corresponding esters of the aforementioned acids (i.e., dimethylterephthalate). Of these, 2,6-polyethylene naphthalate (PEN), copolymers of PEN and polyethylene terepthalate (PET), PET, polypropylene terephthalate, polypropylene naphthalate, polybutylene terephthalate, polybutylene naphthalate, polyhexamethylene terephthalate, polyhexamethylene naphthalate, and other crystalline naphthalene dicarboxylic polyesters. PEN, PET, and their copolymers are especially preferred because of their strain induced birefringence, and because of their ability to remain permanently birefringent at elevated environmental temperatures.

Suitable materials for the second polymer in some film constructions include materials that are substantially non-positively birefringent when oriented under the conditions used to generate the appropriate level of birefringence in the first polymeric material. Suitable examples include polycarbonates (PC) and copolycarbonates, polystyrene-polymethylmethacrylate copolymers (PS-PMMA), PS-PMMA-acrylate copolymers such as, for example, those available under the trade designations MS 600 (50% acrylate content) from Sanyo Chemical Indus., Kyoto, Japan, NAS 21 (20% acrylate content) and NAS 30 (30% acrylate content) from Nova Chemical, Moon Township, Pa., polystyrene maleic anhydride copolymers such as, for example, those available under the trade designation DYLARK from Nova Chemical, acrylonitrile butadiene styrene (ABS) and ABS-PMMA, polyurethanes, polyamides, particularly aliphatic polyamides such as nylon 6, nylon 6,6, and nylon 6,10, styrene-acrylonitrile polymers (SAN) such as TYRIL, available from Dow Chemical, Midland, Mich., and polycarbonate/polyester blend resins such as, for example, polyester/polycarbonate alloys available from Bayer Plastics under the trade designation Makroblend, those available from GE Plastics under the trade designation Xylex, and those available from Eastman Chemical under the trade designation SA 100 and SA 115, polyesters such as, for example, aliphatic copolyesters including CoPET and CoPEN, polyvinyl chloride (PVC), and polychloroprene.

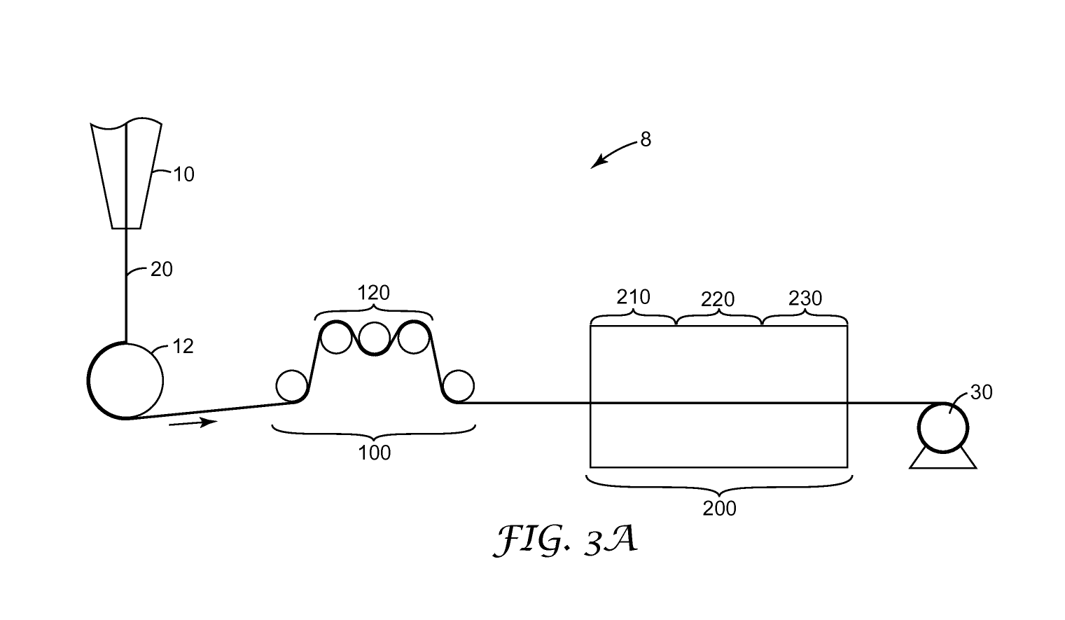

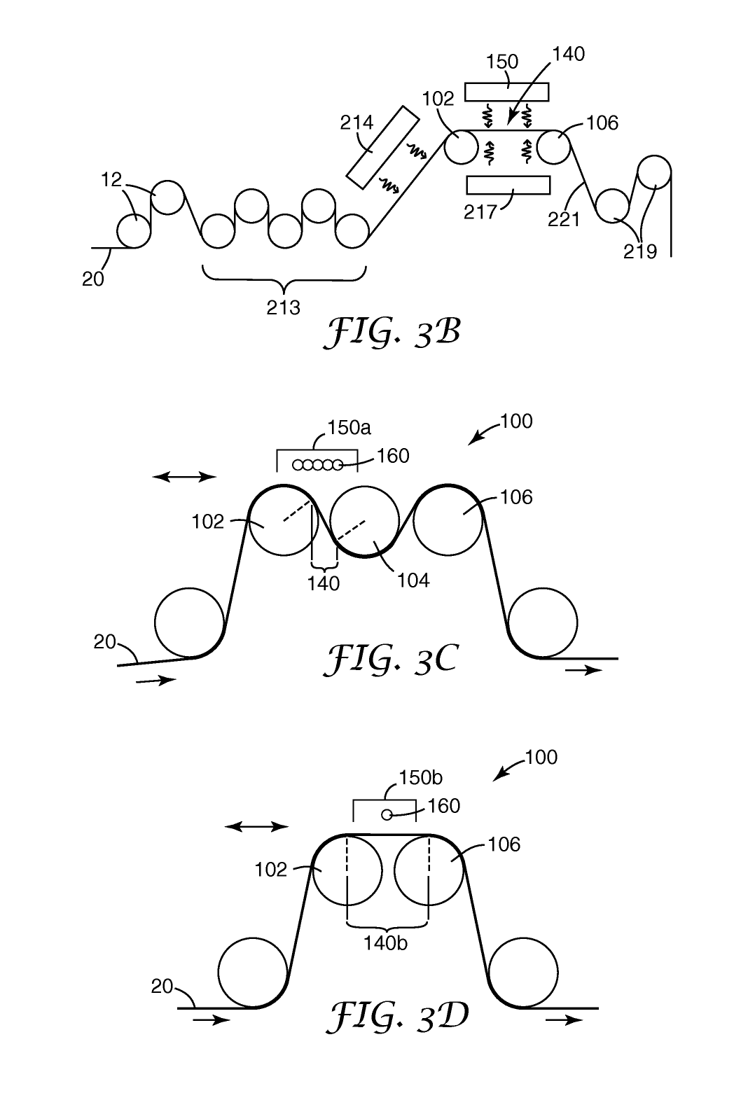

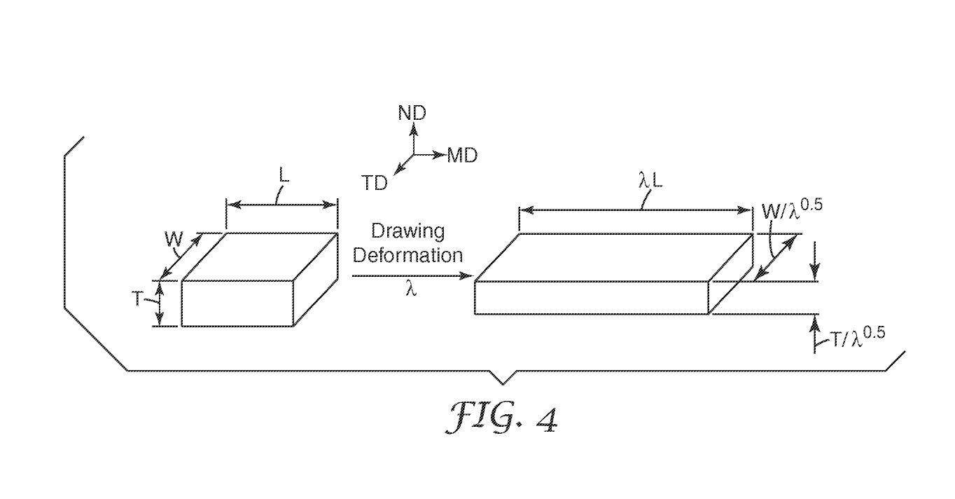

FIG. 3A is a schematic diagram of a film line 8 using a length orienter (LO) for drawing and orienting polymeric film. To impart particular optical and/or physical characteristics to the finished film, polymer 20 can be extruded through a film die 10, the orifice of which can be controlled by a series of die bolts. In one embodiment, a first polymer material and a second polymer material, as described above, are heated above their melting and/or glass transition temperatures and fed into a film die 10.

A feedblock (not shown) feeds a film extrusion die 10. Feedblocks useful in the manufacture of the present invention are described in, for example, U.S. Pat. No. 3,773,882 (Schrenk) and U.S. Pat. No. 3,884,606 (Schrenk), the contents of which are incorporated by reference herein to the extent it is not inconsistent with the present disclosure. An extrudate film 20 leaving the die is typically in a melt form.

In some embodiments, a layer multiplier (not shown) splits the multilayer flow stream, and then redirects and “stacks” one stream atop another to multiply the number of layers extruded. An asymmetric multiplier, when used with extrusion equipment that introduces layer thickness deviations throughout the stack, may broaden the distribution of layer thicknesses so as to enable a resulting multilayer film to have polymeric optical layer pairs corresponding to a desired portion of the visible spectrum of light, and provide a desired layer thickness gradient, if desired. In some embodiments, skin layers are introduced into the multilayer optical film by feeding skin layer resin to a skin layer feedblock.

Extruded films can subsequently be oriented, for example by stretching, at ratios determined by the desired properties. Longitudinal stretching can be done by pull rolls in a longitudinal stretch zone 120 of a length orienter (LO) 100, as shown in FIG. 3A. The length orienter typically has one or more longitudinal stretch zones. Transverse stretching can be done in a tenter oven 200 shown in FIG. 3A. The tenter oven 200 usually contains at least a preheat zone 210 and a transverse stretch zone 220. Often the tenter oven 200 also contains a heat set zone 230, as shown in FIG. 3A. Systems can be designed to contain one or more of any or all of these zones. Heat setting is described in commonly owned copending U.S. patent application Ser. No. 11/397,992, filed on Apr. 5, 2006, entitled “Heat Setting Optical Films,” herein incorporated by reference.

After processing, film 20 can be wound on winding roll 30. In one aspect, the present disclosure is directed to a method of making a roll of optical film useful, for example, in an optical display, in which the block axis of the film is generally aligned with the length of the roll. Rolls of this film, typically a reflective optical film such as a reflective polarizing film, may be easily laminated to rolls of other optical films such as absorbing polarizers that have a block state axis along their length.

A film 20 may be laminated with, embossed with, or have otherwise disposed thereon a structured surface film such as those available under the trade designation BEF from 3M Company of St. Paul, Minn. The structured surface film includes an arrangement of substantially parallel linear prismatic structures or grooves. In some exemplary embodiments, the optical film may be laminated to a structured surface film including an arrangement of substantially parallel linear prismatic structures or grooves. In an exemplary embodiment, the grooves are aligned along the MD direction, with the block axis of a reflective polarizer film. This is especially useful where the film will be combined with other films in a roll-to-roll process. In other embodiments, the grooves may be aligned along the TD direction or another direction. In other exemplary embodiments, the structured surface may include any other types of structures, a rough surface or a matte surface. Such exemplary embodiments may also be produced by inclusion of additional steps of coating a curable material onto the film 20, imparting surface structures into the layer of curable material and curing the layer of the curable material.

Since exemplary reflective polarizers made according to the processes described herein have a block axis along the downweb (MD) direction, the reflective polarizers may simply be roll-to-roll laminated to any length oriented polarizing film. In other exemplary embodiments, the film may be coextruded with a polymer comprising dichroic dye material or coated with a polyvinyl alcohol-containing (PVA) layer prior to the second draw step.

For uniaxial stretching, stretch ratios of approximately 1.5:1 to 10:1 may be used. Those skilled in the art will understand that other stretch ratios may be used as appropriate for a given film.

For the purpose of this application, the term “transverse stretch zone” refers to either a purely transverse stretch zone or a simultaneous biaxial stretch zone in a tenter oven. By “tenter”, we mean any device by which film is gripped at its edges while being conveyed in the machine direction. Typically, film is stretched in the tenter. In some embodiments, the stretching direction in a tenter with diverging rails along which the grippers travel will be perpendicular to the machine direction (the stretching direction will be the transverse direction or cross-web direction), but other stretching directions, for example at angles other than the angle perpendicular to film travel, are also contemplated.

Optionally, in addition to stretching the film in a first direction that is other than the machine direction, the tenter may also be capable of stretching the film in a second direction, either the machine direction or a direction that is close to the machine direction. Second direction stretching in the tenter may occur either simultaneously with the first direction stretching, or it may occur separately, or both. Stretching within the tenter may be done in any number of steps, each of which may have a component of stretching in the first direction, in the second direction, or in both. A tenter can also be used to allow a controlled amount of transverse direction relaxation in a film that would shrink if not gripped at its edges. In this case, relaxation may take place in a relaxation zone.

A common industrially useful tenter grips the two edges of the film with two sets of tenter clips. Each set of tenter clips is driven by a chain, and the clips ride on two rails whose positions can be adjusted in such a way that the rails diverge from one another as one travels through the tenter. This divergence results in a cross-direction stretch. Variations on this general scheme are contemplated herein.

Some tenters are capable of stretching film in the machine direction, or a direction close to the machine direction, at the same time they stretch the film in the cross-direction. These are often referred to as simultaneous biaxial stretching tenters. One type uses a pantograph or scissors-like mechanism to drive the clips. This makes it possible for the clips on each rail to diverge from their nearest-neighbor clips on that rail as they proceed along the rail. Just as in a conventional tenter, the clips on each rail diverge from their counterparts on the opposite rail due to the divergence of the two rails from one another.

Another type of simultaneous biaxial stretching tenter substitutes a screw of varying pitch for each chain. In this scheme, each set of clips is driven along its rail by the motion of the screw thread, and the varying pitch provides for divergence of the clips along the rail. In yet another type of simultaneous biaxial stretching tenter, the clips are individually driven electromagnetically by linear motors, thus permitting divergence of the clips along each rail. A simultaneous biaxial stretching tenter can also be used to stretch in the machine direction only. In this case, machine direction stretching takes place in a machine direction stretch zone. In this application, transverse direction stretching, relaxation, and machine direction stretching are examples of deforming, and transverse stretch zone, relaxation zone, or machine direction stretch zone are examples of deformation zones. Other methods for providing deformation in two directions within a tenter may also be possible, and are contemplated by the present application.

The film 20 provided into LO 8 may be a solvent cast or an extrusion cast film. In the embodiment illustrated in FIG. 3A, the film 20 is an extruded film expelled from an extruder die 10 and including at least one, and preferably two polymeric materials. The film 20 may vary widely depending on the intended application of the optical film product, and may have a monolithic structure as shown in FIG. 1A, a layered structure as shown in FIG. 1B, or a blend structure as shown in FIG. 2, or a combination thereof.

In an exemplary embodiment, the die 10 lip profile is adjustable with a series of die bolts. For multilayer films, multiple melt streams and multiple extruders are employed. The extrudate is cooled on a rotating casting roll or wheel 12. The film at this point is often referred to as a “cast web”. To orient the film, the film or cast web is stretched in the machine direction, transverse direction, or both depending on desired properties of the finished optical film. Film processing details are described, for example in U.S. Pat. No. 6,830,713 (Hebrink et al.), hereby incorporated by reference. For simplicity, the present specification shall use the term “film” to denote film at any stage of the process, without regard to distinctions between “extrudate,” “cast web” or “finished optical film.” However, those skilled in the art will understand that film at different points in the process can be referred to by the alternate terms listed above, as well as by other terms known in the art.

In an exemplary embodiment, the materials selected for use in the film 20 are free from any undesirable orientation prior to the draw process. Alternatively, deliberate orientation can be induced during the casting or extrusion step as a process aid to the draw step. For example, the casting or extrusion step may be considered part of the draw step. The materials in the film 20 are selected based on the end use application of the optical film, which in one example will become birefringent and may have reflective properties such as reflective polarizing properties. In one exemplary embodiment described in detail in this application, the optically interfaced materials in the film 20 are selected to provide a film with the properties of a reflective polarizer.

The term orient as used herein refers to a process step in which the film dimensions are changed and molecular orientation is induced in the polymeric materials making up the film. The tendency of a polymeric material to orient under a given set of processing conditions is a result of the visco-elastic behavior of polymers, which is generally the result of the rate of molecular relaxation in the polymeric material.

The relative strength of optical orientation depends on the materials and the relative refractive indices of the film. For example, a strong optical orientation may be in relation to the total intrinsic (normalized) birefringence of the given materials. Alternatively, the draw strength may be in relation to the total amount of achievable normalized index difference between the materials for a given draw process sequence. It should also be appreciated that a specified amount of molecular orientation in one context may be strong optical orientation and in another context may be considered weak or non-optical orientation.

For example, a certain amount of birefringence along a first in-plane axis may be negligible when viewed in the context of a very large birefringence along the second in-plane axis. As the birefringence along the second in-plane axis decreases, the slight orientation along the first in-plane axis becomes more optically dominant. Processes which occur in a short enough time and/or at a low enough temperature to induce some or substantial optical molecular orientation of at least one material included in the optical film of the present disclosure are weak or strong optically orienting draw processes, respectively. Processes that occur over a long enough period and/or at high enough temperatures such that little or no molecular orientation occurs are weak or substantially non-optically orienting processes, respectively.

Although the draw processes define the orientational changes in the materials to a first approximation, secondary processes such as densification or phase transitions such as crystallization can also influence the orientational characteristics. In the case of extreme material interaction (e.g. self-assembly, or liquid crystalline transitions), these effects may be over-riding. In typical cases, for example, a drawn polymer in which the main chain backbone of the polymer molecule tends to align with the flow, effects such as strain-induced crystallization tend to have only a secondary effect on the character of the orientation.

Strain-induced and other crystallization do, however, have a significant effect on the strength of such orientation (e.g., may turn a weakly orienting draw into a strongly orienting draw). Therefore, in an exemplary embodiment, none of the materials selected for the use in the film 20 is capable of rapid crystallization, and at least one of the materials is not capable of appreciable crystallization under the processing conditions applied in the draw steps. As a result, in some applications, a coPEN that crystallizes more slowly than PEN under the first set of processing conditions, such as a copolymer of PEN and PET, is used. A suitable example is a copolymer of 90% PEN and 10% PET, referred to herein as 90/10 coPEN or, or alternatively, as low melting point PEN (LmPEN).

FIG. 3B illustrates a portion of another suitable embodiment of a film line. The continuous film 20 may be conveyed by rollers 12 into a preheat zone. The conveying rollers 12 may be used to adjust film tension, such as by a dancing mechanism that alters the film path length or through slight differential speed differences (typically less than 1% variation) or both. The preheat zone may comprise a bank of heated rollers 213, a radiant heating source 214, a pre-heat oven, or any combination of these. A typical radiant heating source is an infra-red (IR) bulb or bank of bulbs. The heated rollers may be driven, for example to decrease scuffing or premature stretching of the film. The speeds may increase between rollers, for example to account for thermal expansion. The film 20 may be also stretched slightly, for example to increase film tension or prevent film sagging and loss of flatness. Typically, such pre-stretching and speed adjustments are less than 20%, e.g. less than a 1.2 draw ratio. The amount of pre-heating required depends on the materials and process film speeds. Typically, the film is heated to near the glass transition temperature, such as within 20 degrees C., of at least one material in the film.

Following pre-heating, the film 20 is conveyed to one or more stretching zones, each comprising an initial slow roll 102 and a final fast roll 106. Each is typically driven so that the slow roll 102 resists the pull of the film from the action of the fast roll 106 through the draw gap 140. In an exemplary embodiment, the film 20 is further heated in the draw gap 140.

One typical heating method is radiant heating, such as by IR heating assemblies 150 and/or 217. The film 20 is typically heated above the glass transition temperature of at least every longitudinally (MD) continuous phase or layer in the film 20. A longitudinally (MD) continuous phase is any individual layer, or any continuous phase, such as a continuous phase in a blend polarizer. Sometimes, a cold stretching is included in which the film 20 is drawn slightly below the glass transition temperature of at least one longitudinally (MD) continuous phase or layer in the film 20. Typically, such cold stretching is within 10 degrees C. of that glass transition temperature. The slow roll 102 may also be a heated roll.

In an exemplary embodiment, after draw across the gap 140, the film 20 is quenched. Typically, the fast roll 106 is a chilled roll set to at least begin the quenching of the film 20. In practice, it may be found that film 20 is not quenched immediately upon contact with fast roll 106 but is instead further drawn for a short distance over fast roll 106. In one embodiment, the further drawing occurs over about an inch of film 20 after contact with fast roll 106, thereby increasing the effective aspect ratio L/W. As discussed further below, the effective aspect ratio L/W is the ratio of the effective draw gap dimension to the width dimension. Further cooling may continue, such as through the quenching action of additional rolls 219. These rolls 219 may be set at a reduced speed relative to the fast roll 106, for example to decrease the film tension and allow MD shrinkage or to account for thermal contraction upon cooling. Again, the subsequent conveying rollers may be used to adjust film tension, such as by a dancing mechanism that alters the film path length or through slight differential speed differences (typically less than 1% variation) or both. When the quenching is extended past the fast roll 106 to allow MD shrinkage control, then the speed adjustments can be larger, but typically are less than 20%. In some cases, a final finishing zone 221 can be used. In one embodiment, finishing zone 221 is also heated, such as with radiant heaters, to allow MD shrinkage while separating this process from the tension in a stretching draw gap.

After drawing the film 20 along MD, the film 20 may be further treated by heating. The film 20 may be heat set at a temperature above a film temperature used in the stretching process. Heat setting is described in commonly owned copending U.S. patent application Ser. No. 11/397,992, filed on Apr. 5, 2006, entitled “Heat Setting Optical Films,” herein incorporated by reference. Heat setting may be used to alter the properties of the drawn film 20 in a process separated from the main drawing. Additional drawing or strain relaxation can be coupled with the applied heat during heat setting. The film 20 may also be annealed at a temperature below a film temperature used in the stretching process with or without additional strain relaxation, for example to alter the shrinkage characteristics.

Heat setting may be accomplished in diverse manners. The film 20 may be heated to a higher temperature during a final portion of draw. The film 20 may be heated after drawing. The film 20 may be heat set in a separate process step. For example, the film may be stretched in a Length Orienter and then heat-set in a separate oven or heating device. The oven or heating device may be on-line in a continuous process or off-line in a subsequent process. A cooling step, for example to room temperature, may then exist on-line or implicitly in the process of moving to an off-line step.

The oven or heating device may be equipped with an edge gripping mechanism, such as found in a tenter oven device. The edge gripping mechanism may be a clip mechanism attached to a rolling chain along a rail or track as found in many conventional tenters in which the transverse direction draw ratio (TDDR) can be adjusted through the course of the heat setting. Alternatively, the clips may be freely attached to the track by a mounting that is driven independently, such as by a magnetic field as found in simultaneously biaxially orienting LISIM™-driven tenters, available from Bruckner of Sigsdorff, Germany, and described in U.S. Pat. Nos. 4,675,582; 4,825,111; 4,853,602; 5,036,262; 5,051,225; 5,072,493; 5,753,172; 5,939,845 and 6,043,571. In exemplary embodiments of systems of the present disclosure, the TDDR and machine direction draw ratio (MDDR) may be adjusted during the course of heat setting.

The oven or heating device may convey the film 20 using rollers that contact the edges or face of the film 20. For example, the heating device may be configured as a draw gap, such as in a length orienter. The film 20 can be heated using various methods. Non-contact methods of heating such as infra-red heaters may allow higher heat setting temperatures without loss of film integrity.

The TDDR and/or the MDDR can be adjusted in the course of heat setting, as constrained by the flexibility of the particular configuration of the equipment (e.g. conventional tenter, LISM tenter, Length Orienter or other roll driven system) used for the heat setting process step. The MDDR can be maintained, increased or relaxed. When conveyed by rollers, a downstream roll may be driven at a slower speed to decrease the MDDR and relax the film 20 in the MD. Reducing the MDDR during heat setting can reduce shrinkage. In such cases the final MDDR is typically at least 80%, more typically at least 90% of the MDDR before heat setting.

When conveyed by rollers, a downstream roll may be driven at a higher speed to increase the MDDR. A typical range for increased MDDR in such cases may be an increase of 1-20%.

The nature of the TDDR constraint during the process can also affect the relationship between the indices. For example, TD tension imposed by a TD constraint may increase the differences between the TD and ND refractive indices. Such constraint may be achieved in one embodiment by simply holding the film in TDDR, such as by parallel gripping elements on the edges of the film while conveying the film through an oven or past a heating device. Lack of TD constraint or the reduction of the TD constraint, such as by a diverging rail and clip system, may actually allow partial TD strain recovery, that is, a reduction in TDDR. In some cases, this may result in a reduction in the relative birefringence. In other cases, the increase in the relative birefringence may be small, e.g. less than 0.01 at 632.8 nm. In some instances, the MDDR and TDDR profiles can be controlled during the progress of heat setting. For example, the MDDR could be increased first to increase draw index and then relaxed slightly to partially relieve residual stresses and thus reduce shrinkage. This may be coordinated with changes in TDDR during the course of heat setting in some process configurations.

FIGS. 3C and 3D are schematic diagrams of two embodiments of a length orienter threading system. In FIG. 3C, pull rolls 102, 104, and 106 are set up in an S-wrap configuration. In FIG. 3D, the pull rolls are set up in a straight or tabletop configuration. In exemplary embodiments, in relative terms, roll 102 rotates slowly, roll 104 rotates at an intermediate rate of speed, and roll 106 rotates quickly. In exemplary embodiments, in relative terms, roll 102 is heated and roll 106 is cooled.

The term length orienter encompasses the range of stretching apparatuses in which a continuous film or web of polymer 20 is conveyed and stretched in the span or draw gap 140 between at least one pair of rollers, in which the linear (tangential) velocity of the downstream roll 106 is higher than the linear velocity of the upstream roll 102 of the pair. The ratio of the differential velocities along the film path, fast to slow roll, is approximately equal to the machine-direction draw ratio (MDDR) across the span 140.

Film 20 is conveyed through a series of pre-heated rollers 102, 104, 106 to a draw gap 140, 140b. The film 20 is drawn due to the differences in speed between the initial and final rollers defining the draw gap 140, 104b. Typically, the film 20 is heated, for example, with infrared radiation, as it spans the gap 140, 140b to soften the film 20 and facilitate the drawing above the glass transition temperature. The embodiments depicted in FIGS. 3B and 3D employ heating assemblies 150a-b for providing a distribution of heat to the longitudinal stretch zone 140 or 140b of the film 20.

In the embodiment shown in FIG. 3C, the heating assembly 150a comprises three transverse infrared heating elements 160. Although this particular embodiment illustrates a set of three heating elements 160, any number and type of heating elements can be used, depending on the design considerations of the system. For example, a system having a single heating element (heating assembly 150b) is shown in FIG. 3D. Each transverse heating element 160 can be a single heater spanning the entire width of the film area to be controlled, or a plurality of smaller heaters, including point sources of heat, arranged to provide the desired amount of heat to the film area to be controlled. Combinations of point sources and extended sources of heat are also contemplated.

The illustrated process can be used for many products, including visible, colored and infra-red mirror film products. Caliper (thickness) and draw ratio variations of optical films can cause undesired color. For example, films designed to reflect a certain band of color in the visible wavelengths can shift color. In another example, films designed to reflect a narrow infra-red band may exhibit visible color due to caliper fluctuation. The width of the reflection band allowed, without such color, decreases as the caliper variations increase. Reduced caliper variation allows for an increased band width with resulting increased reflective power.

The phrase “consisting essentially of a uniaxial stretch” refers to stretching a film uniaxially in a first stretch direction and optionally, in a second stretch direction different than the first stretch direction, such that the stretching in second direction, if any, does not produce or appreciably alter the in-plane birefringence in the continuous layer along MD. Stretching in the second direction can be performed simultaneously as the stretching in the first direction, or subsequent to the stretching in the first direction, as desired. Stretching the film in a second direction such that the stretching in the second direction alters the in-plane birefringence in the continuous layer along TD is termed a “biaxial” stretch. The second direction can be drawn before the first direction, so the terms first and second are used for clarity of discussion but do not imply a time sequence.

Perfect uniaxial stretching conditions, with an increase in dimension in the machine direction, result in MDDR, TDDR, and NDDR of λ, (λ)^{-1/2}, and (λ)^{-1/2}, respectively, as illustrated in FIG. 4 (assuming constant density of the material). In other words, assuming uniform density during the stretch, a uniaxially oriented film is one in which TDDR=(MDDR)^{-1/2} throughout the stretch. A useful measure of the extent of uniaxial character, U, can be defined as:

$$U = \frac{\frac{1}{TDDR} - 1}{{MDDR}^{1 / 2} - 1}$$

Perfect uniaxial stretching conditions, with an increase in dimension in the transverse direction, result in TDDR, MDDR, and NDDR of λ, (λ)^{-1/2}, and (λ)^{-1/2}, respectively (assuming constant density of the material). In other words, assuming uniform density during the stretch, a uniaxially oriented film is one in which MDDR=(TDDR)^{-1/2} throughout the stretch. In this analogous case to MD stretching, the extent of uniaxial character, U, can be defined as:

$$U = \frac{\frac{1}{MDDR} - 1}{{TDDR}^{1 / 2} - 1}$$

For a perfect uniaxial stretch, U is one throughout the stretch. When U is less than one, the stretching condition is considered “subuniaxial”. If the film is biaxially stretched so that MDDR is greater than unity, U becomes negative. When U is greater than one, the stretching condition is considered “super-uniaxial”. States of U greater than unity represent various levels of over-relaxing. These over-relaxed states produce an MD compression from the boundary edge. If the level of MD compression is sufficient for the geometry and material stiffness, the film will buckle or wrinkle.

A change in density of the material can occur for a variety of reasons including, for example, due to a phase change, such as crystallization or partial crystallization, caused by stretching or other processing conditions. Where the density of the film changes by a factor of ρ_{f}, where ρ_{f}=ρ₀/ρ with ρ being the density at the present point in the stretching process and ρ₀ being the initial density at the start of the stretch, then U for a TD stretch can be corrected for changes in density to give U_{f} according to the following formula:

$${U}_{f} = \frac{\frac{1}{MDDR} - 1}{{( \frac{TDDR}{{ρ}_{f}} )}^{1 / 2} - 1}$$

A similar density correction can be made to the U formula for an MD stretch, above.

A fundamental study of the base caliper response of a visco-elastic film drawn in a length orienter reveals two preferred regimes for process operation. The first preferred draw regime is one in which the process yields a nearly uniaxially oriented film, hereafter referred to as the “uniaxial” regime. The second preferred draw regime is one in which the process yields a nearly “pure shear extension” in the major, center portion of the drawn film, and yields a relatively more uniaxial condition in a minor edge portion of the drawn film, hereafter referred to as the “planar extension” regime.

The two preferred regimes represent certain extremes in the process conditions. In the uniaxial regime, the resulting film has uniaxial orientation and U is near 1; in one embodiment, U is greater than or equal to about 0.7. The uniaxial regime is achieved using relatively narrow films in relatively long heated draw gaps at relatively low draw ratios. Conversely, the planar extension regime is achieved using relatively wide films in relatively short heated draw gaps at relatively high draw ratios. In the planar extension regime, the resulting film has biaxial orientation and U is near 0; in one embodiment, U is less than or equal to about 0.2. When U is either near 1 or near 0, the film exhibits caliper uniformity; when U is about 0.5, the film exhibits caliper non-uniformity.

The absolute sizes or levels of film width (W), process heated draw gap (L) and draw ratio (DR) are relative to each other. For example, the aspect ratio of the heated draw gap to the film width, i.e. L/W, is a key factor. The critical aspect ratio to achieve either regime is in turn a function of the level of MD draw; e.g. a given aspect ratio representative of the planar extension regime at one draw ratio may yield the uniaxial regime at a much lower draw ratio as further detailed in the following.

Reference to a “heated draw gap” or “effective draw gap” refers to the heated length of a draw gap 140 in which almost all of the drawing occurs across that gap, e.g. at least 95% or 99% of the draw accomplished between the points of contacts of the film with the rolls defining a given gap. Thus, an effective draw gap may be the length between the tangents of adjacent rollers in one embodiment. In another embodiment, an effective draw gap may be shorter than the length between tangents if the heaters are set to heat a shorter portion of the film 20 in the draw gap 140. In yet another embodiment, the effective draw gap may be longer than the length between tangents if there is slippage on the rolls and residual heating outside of draw gap 140 or ineffective quenching. In this case, the gap may be considered to span between rollers where slippage does not occur. Slippage as defined here means that some relative motion between the film and roller occurs across the entire face of the roll contacted. This is to be understood separately from scuffing, in which some motion occurs over only a portion of the roll surface, e.g. during quenching without relative motion at the final contact point of the film and the roller along the direction of travel. The effective aspect ratio L/W is the ratio of the effective draw gap dimension to the width dimension.

A variety of quantities are useful in describing the uniformity of the draw, including the draw ratios or dimensional length changes in the three process directions. The three process directions are along the machine direction of film travel and length orientation (MD), the in-plane crossweb direction transverse to this draw direction (TD), and the out-of-plane thickness direction normal to each of these (ND). It should be understood that while the present disclosure refers to three “orthogonal directions,” the corresponding directions may not be exactly aligned (e.g., in MD and TD) due to non-uniformities in the film. The orthogonal directions also coincide with the average directions of draw within the film after it exits the LO process. The draw ratios, λ_{MD}, λ_{TD} and λ_{ND} are the ratios of final to initial lengths of the respective sides of a volume element of the film measured at the same temperature and pressure.

For an incompressible film, the product of the three draw ratios is unity. For a compressible or densifying film, e.g. via crystallization, the product of the three draw ratios is equal to the ratio of the final to the initial volume at the same temperature and pressure. The draw ratios in the film may vary as functions of both the MD and TD positions. During the drawing, severe changes occur to the film in MD as the film travels and is drawn in that direction. Non-uniformity may persist along MD in the final film. However, the thrust of this disclosure is improved uniformity as measured across TD. Thus the improved uniformity of the draw ratios and resulting physical properties of the film as a function of TD position within the final film are described.

The uniaxial regime, illustrated in FIG. 4 may be distinguished by a variety of physical measurements. Given a flat cast web, the thickness profile resulting after drawing is mostly flat with only a slight upturn at the edge. In an exemplary embodiment, the caliper profile, normalized by the initial profile, increases no more than 10% at the edge.

In some embodiments of the present disclosure, an optical film may be uniaxially-oriented, for example, by stretching (i.e., drawing) in a substantially single direction. A second orthogonal direction may be allowed to neck into some value less than its original length, as desired. In some exemplary embodiments, the first optical layers may be oriented or stretched (i.e., drawn) in a manner that departs from perfectly uniaxial draw but still results in a reflective polarizer that has a desired optical power. Such nearly uniaxial stretch may be referred as “substantially uniaxial” stretch. The term “uniaxial” or “substantially uniaxial” stretch refers to a direction of stretching that substantially corresponds to either the x or y axis (an in-plane axis or direction) of the film. For the purposes of the present disclosure, the term “uniaxial stretch” shall be used to refer to both perfectly “uniaxial” and “substantially uniaxial” stretches. However, other designations of stretch directions may be chosen. In many embodiments, the reflective polarizer is drawn uniaxially or substantially uniaxially in the transverse direction (TD), while allowed to relax in the machine direction (MD) as well as the normal direction (ND). Suitable apparatuses that can be used to draw such exemplary embodiments of the present disclosure and definitions of uniaxial or substantially uniaxial stretching (drawing) that can be used to draw such exemplary embodiments of the present disclosure are described in U.S. Pat. No. 6,916,440, and U.S. Patent Application Publications No. US2002/0190406, US2002/0180107, US2004/0099992 and US2004/0099993, the disclosures of which are hereby incorporated by reference herein.

The uniaxial regime is partially distinguished by a relatively large degree of neckdown across the width of the film. For an incompressible material, the maximum amount of neckdown may be estimated from the MD draw ratio, λ_{MD}. More specifically, the width of the film can be reduced by up to a factor of (λ_{MD})^{-1/2}. The neckdown is directly related to this width reduction factor. The neckdown is defined as zero when there is no reduction in width; thus, a convenient definition for the neckdown is unity minus the ratio of the final to initial width. It follows then that the maximum neckdown is the quantity 1−(λ_{MD})^{1/2} (or this fractional value given as a percentage). The thickness is reduced similarly. To fall within the uniaxial regime, the actual neckdown reduction in an exemplary embodiment is at least 80% of the maximum neckdown. The regime may also be partially distinguished by the indices of refraction, in which the crossweb TD index and thickness ND index differ by less than 15% of the difference between the MD and ND indices.

Films falling within the uniaxial regime may be produced by methods including batch processes and the substantially uniaxial stretching processes described in commonly owned U.S. Pat. Nos. 6,939,499; 6,916,440; 6,949,212; and 6,936,209; and commonly owned U.S. Patent Application Ser. No. 60/713,620 (Attorney Reference No. 61165US002), filed Aug. 31, 2005; all incorporated herein by reference.

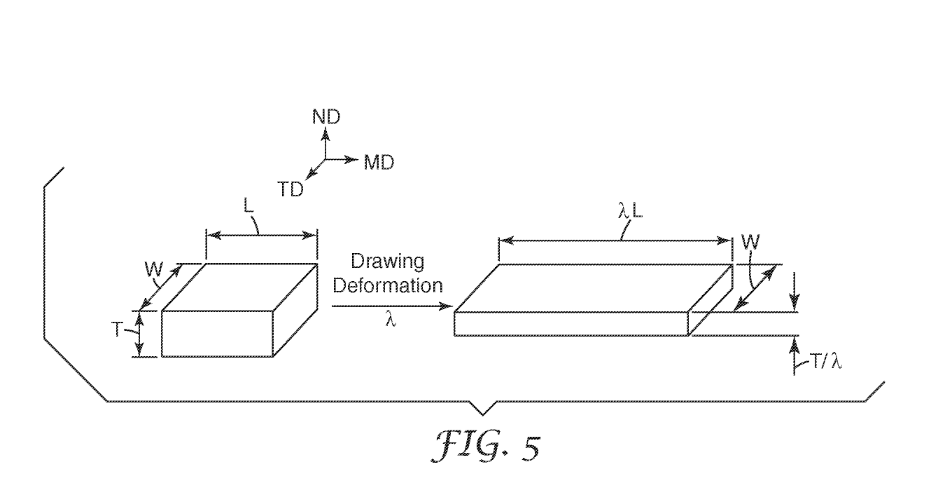

FIG. 5 is a schematic illustration of the deformation of a unit of film in a planar extension regime. The planar extension regime may likewise be distinguished by various physical measurements. The limiting thickness at the center of the film is equal to the product of 1/λ_{MD} times the initial thickness. The center of the film should be no more than 10% higher than this value. The limiting neckdown is zero. To be in the planar extension regime, the actual neckdown is no more than 20% in an exemplary embodiment.

For a given condition, λ_{MD} is approximately constant across TD when MD variations are eliminated. However, both λ_{TD} and λ_{ND} show distinct TD profile characteristics that describe the various draw regimes, particularly the uniaxial and planar extension regimes of interest. Because λ_{ND} is readily measured as the ratio of the final to initial thickness of the film, its behavior will be described first.

The following examples include exemplary materials and processing conditions in accordance with different embodiments of the disclosure. The examples are not intended to limit the disclosure but rather are provided to facilitate an understanding of the invention as well as to provide examples of materials particularly suited for use in accordance with the various above-described embodiments.

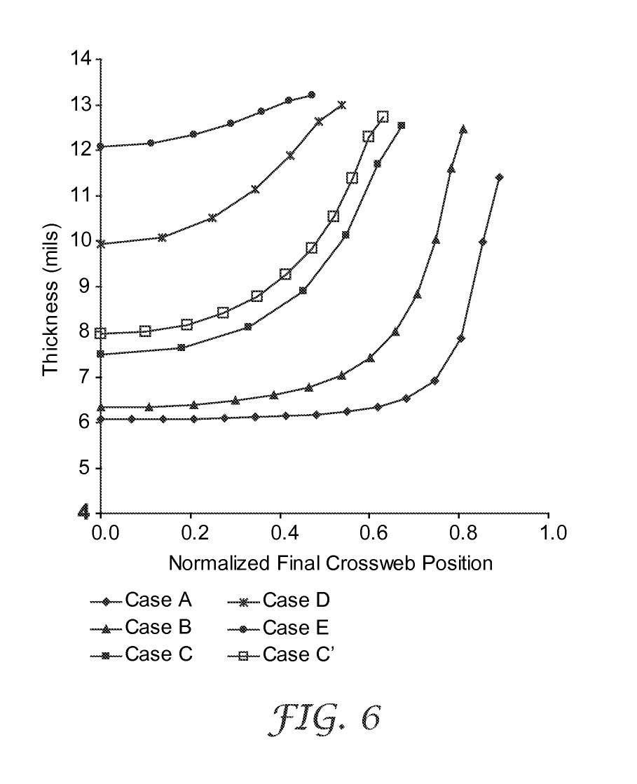

FIG. 6 illustrates the crossweb thickness profile for a series of model optical films comprising a polyester, e.g. polyethylene naphthalate, with various L/W aspect ratios, of initially uniform 0.030″ (0.76 mm) thickness drawn to approximately five times in MD. The data discussed with reference to FIGS. 6-12 are obtained from process modeling, as opposed to experimental results. Details of the modeling procedures are further discussed at the end of the present disclosure.

In case A, L/W=0.5; in case B, L/W=1.0; in case C, L/W=2.1; in case D, L/W=4.2; and in case E, L/W=8.4. These aspect ratios are approximate and may differ by about 30% from the reported values. The limiting thicknesses at the center of the film in the uniaxial and planar extension regimes are thus 0.0134″ (0.34 mm) (T/λ^{0.5}=0.030″/5^{0.5}) and 0.0060″ (0.15 mm) (T/λ=0.030″/5), respectively. The final caliper is plotted against the final deformed crossweb position of the film relative to its initial width. The center of the film is defined by the value of 0.0. The two edges of the initial cast web are defined at the crossweb positions of −1.0 and 1.0. Only half of the symmetric profile is portrayed from a crossweb position of 0 (center) to 1.0 (an initial edge).

Because of neckdown, the final position of the film edge, initially at 1.0, is at a lesser value. Thus, the total width reduction of the drawn film is directly shown in FIG. 6. The neckdown is unity minus this reduction factor according to the previous definition of neckdown. For an MD draw ratio of 5, the limiting width reduction for the uniaxial regime is 0.45 (=1/(5^{0.5})) and the limiting neckdown is thus 55%. As discussed above, to fall within the uniaxial regime, the actual neckdown reduction in an exemplary embodiment is at least 80% of the maximum neckdown, which in this case would be 0.8×55%=44%. Model case E is clearly in the uniaxial regime with a neckdown of 53%. Model case D is on the border of this regime with a neckdown of 46%.

The limiting neckdown is always 0.00 for the planar extension regime. As discussed above, to be in the planar extension regime, the actual neckdown is no more than 20% in an exemplary embodiment. Model case A is clearly in the planar extension regime with a neckdown of 11%. Model case B is weakly in this regime with a neckdown of 19%. Model case C is in neither the uniaxial regime nor the planar extension regime.

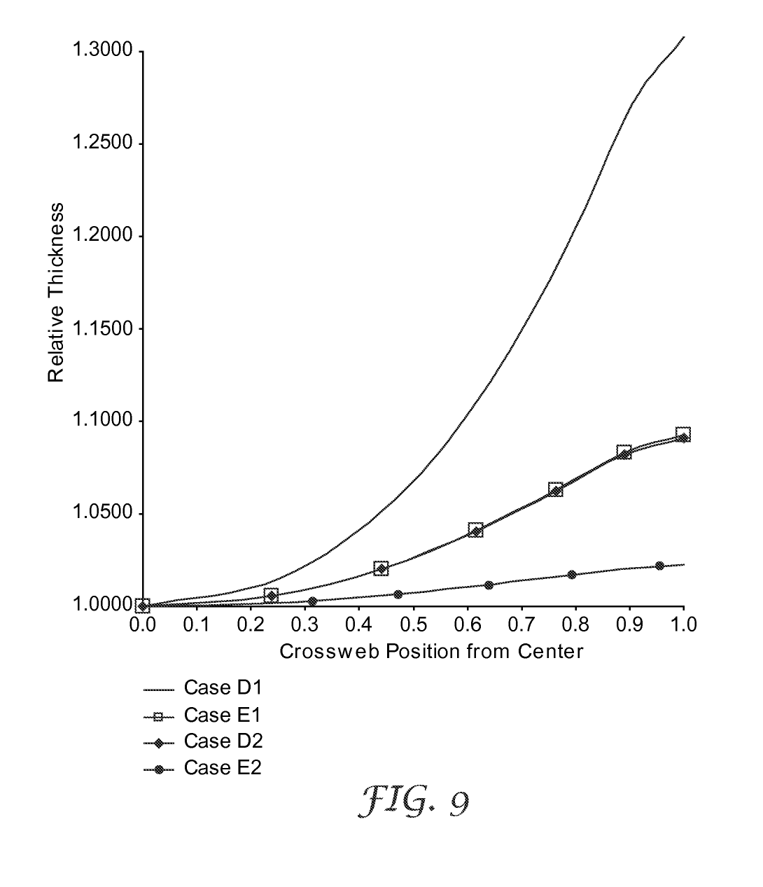

This disclosure focuses on the effects of the geometrical factors of the draw, as opposed to material effect and resulting properties. The material behavior can alter the numerical thresholds for the various aspect ratios for a given MD draw ratio. For example, the amount of neckdown can be influenced by the relative stiffness of the material at the cold, slow roll 102 and in the hot draw gap 140. Case C′ shows how tripling the stiffness of the material in the hot draw gap 140 relative to the material over the cold slow roll 102 can increase the degree of necking and push case C′ farther away from the planar extension regime, as compared to Case C. Nevertheless, it is believed that to a first approximation, given the amount of neckdown, there is a corresponding aspect ratio that recovers the original case (see FIG. 9 and the corresponding discussion). In this example, a slightly lower aspect ratio should approximately recover the original Case C neckdown and profile.

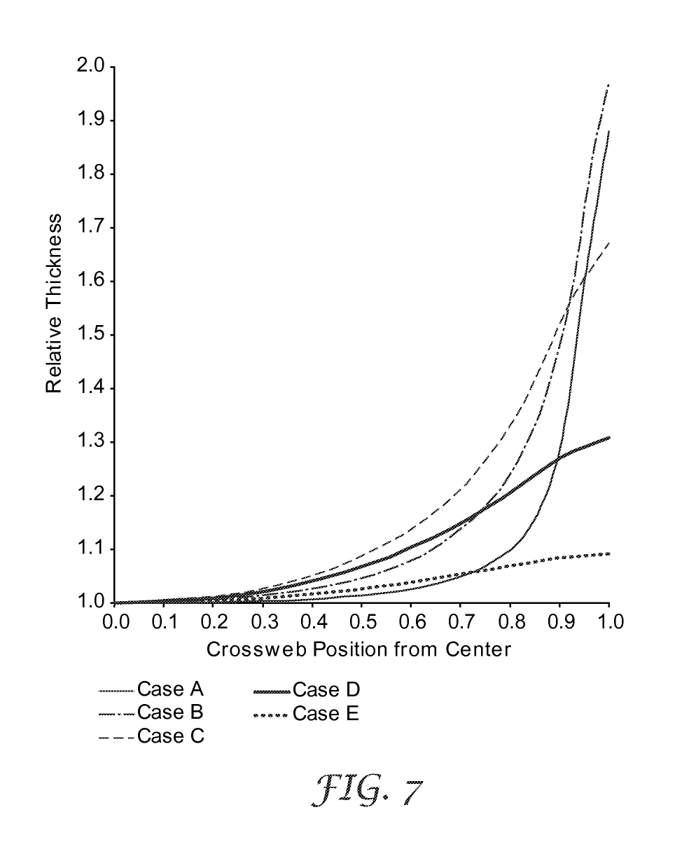

Because original Case C is in the intermediate regime, it is an example of poor crossweb uniformity: almost half the film has more than a 10% variation from the center. This is more clearly illustrated in FIG. 7, in which the crossweb caliper profiles have been normalized by their respective center values and plotted versus their total normalized final crossweb positions (i.e., center at 0 and an edge at 1). FIG. 7 shows that nearly 75% of the film has a maximum variation of 6% for cases A and E, and nearly 75% of the film has a maximum variation of 17% for cases B and D.

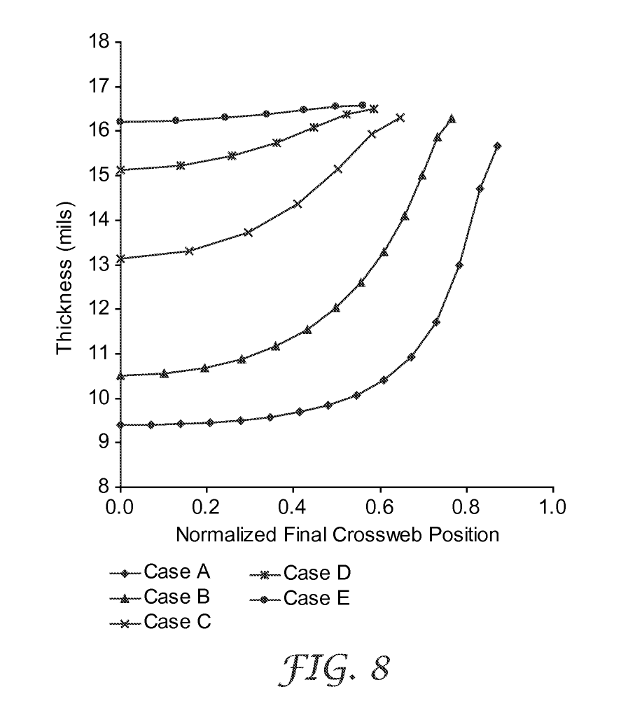

The draw regimes are also strongly defined by the MD draw ratios. The lower the MD draw ratio, the lower the required L/W aspect ratio to achieve the uniaxial regime. Moreover, the planar extension regimes require yet a lower L/W to be achieved. In contrast to FIG. 6, FIG. 8 illustrates the crossweb thickness profile for another series of model films, with the same various L/W aspect ratios, of initially uniform 0.030″ (76 mm) thickness drawn to approximately 3.25 times in MD. The limiting thicknesses of the film in the uniaxial and planar extension regimes are thus 0.0166″ (42 mm) and 0.0092″ (23 mm) respectively. The final caliper is plotted against the final deformed crossweb position of the film relative to its initial width.

For an MD draw ratio of 3.25, the limiting width reduction for the uniaxial regime is 0.55 (=1/(3.25^{0.5})) and the limiting neckdown is thus 45%. As discussed above, to fall within the uniaxial regime, the actual neckdown reduction in an exemplary embodiment is at least 80% of the maximum neckdown, which in this case would be 0.8×45%=36%. Now case D is also squarely in the uniaxial regime, with a neckdown of about 42%.

As discussed above, to be in the planar extension regime, the actual neckdown is no more than 20% in an exemplary embodiment. Case B now has a neckdown of about 24%. Because Case B does not fall in the uniaxial regime or the planar extension regime, it is in the intermediate regime and is characterized by significant nonuniform thickness.

Under certain conditions, similar normalized caliper profiles can be achieved by compensating the aspect ratio with the draw ratio. FIG. 9 demonstrates this concept by comparing model cases D and E for the 3.25 (D2 and E2) and 5.0 (D1 and E1) MD draw ratios. In case D1, L/W=4.2 and the MD draw ratio=5.0; in case E1, L/W=8.4 and the MD draw ratio=5.0; in case D2, L/W=4.2 and the MD draw ratio=3.25; in case E2, L/W=8.4 and the MD draw ratio=3.25. When the caliper profile is normalized by the center value and the crossweb position is normalized by the final edge position (eliminating neckdown), the profile for case D2 overlays case E1; i.e. a lower aspect ratio at lower MD draw ratio corresponds to a higher aspect ratio at a higher draw ratio. Thus, the caliper uniformity on a total mass basis is the same in these two cases. However, the cases are not identical. Case D2 has a neckdown of 42% while case E1 has a neckdown of 53%. Nevertheless, their neckdowns relative to their maximum expected neckdowns are similar: 93% and 96%, respectively.

For a given draw ratio, the system can be driven deeper into the planar extension regime by decreasing the heated draw gap and thus decreasing the effective aspect ratio. Referring back to FIGS. 3A and 3B, the draw gap 140 is set by the physical diameter of the rollers 102, 104, 106, the separation of the roller centers, the location of the heaters 160 over the gap 140 and the radiative shape factors. For example, the heaters 160 can be placed closer to the fast, quench roll 106 to reduce the effective heating. Shielding can be placed to prevent heating to the slow, cold roll 102, e.g. changing the radiative shape factor. Heating efficiency can be improved by using bulbs of a power tuned to the maximum absorption of the resins of interest.

The planar extension regime may also provide improved downweb caliper stability. In some process situations, it is currently believed that shorter effective (e.g. heated) draw gaps amplify downweb caliper fluctuations less than longer effective draw gaps. A shorter draw gap for a given width reduces the aspect ratio and drives the process deeper into the planar extension regime. Moreover, multiple short draw gaps may be used. The use of multiple draw gaps is described in co-pending commonly owned patent application docket no. 61868US002, entitled “Multiple draw gap length orientation process for improved uniaxial character and uniformity,” incorporated herein by reference. Conditions for improved crossweb uniformity may coincide with improved downweb uniformity in the planar extension regime.

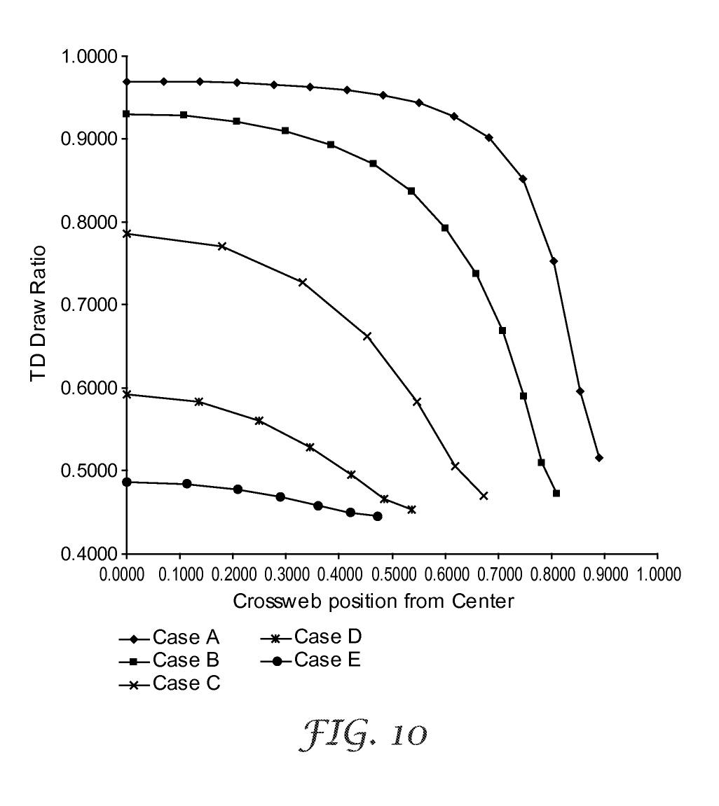

The TD draw ratio also has a crossweb profile. From the product relationship of the draw ratios, the TD draw ratio trend is expected to vary in a reciprocal manner with the thickness. This can be seen by comparing FIG. 10 to FIG. 6. The TD draw ratio uniformity is especially important for crossweb property uniformity. For example, the TD draw ratio may be correlated to the TD refractive index. In turn, the tendency of a film to split (referred to herein as “splittiness”) in the MD may be correlated to this TD refractive index for a given construction. Thus, the ability to accomplish a second draw in TD after a first draw in MD using the LO may in part be related to the TD draw profile.

FIG. 10 clearly shows the TD draw ratio trend at a fixed MD draw ratio of 5.0 for various aspect ratios (which are as defined for the cases of FIG. 6). In these cases, it may be expected that the uniaxial regime would provide splitty films that would be difficult to draw in TD in a second step. Such a second draw step is often used for mirror films.

Thus, the planar extension regime may be preferred for improved runnability of a second step. As used herein, runnability is the ability to operate the drawing process continuously without film web breaks over extended time intervals, such as several hours or days. In an exemplary embodiment, the edge bead resulting from a low TD draw ratio is reduced to a small enough spatial region so that the residual splitty edge lies solely under the gripper clips of the second draw process, e.g. the tenter clips. This is achieved by being deep enough into the planar extension regime. In some cases, due to cold edges that may strengthen the splitty edge relative to the center, it may not be necessary to actually reduce the splitty zone all the way to the width of the clip.

In one example, a typical clip gripper width is about 0.75″ (19 mm). For discussion, let us assume that a TD draw ratio of 0.70 is the minimum allowed for good runnability for a particular construction (e.g. resin choice and layer structure). Case A hits this critical value at about 0.82 out of 0.89 final half width; thus, a 21″ (530 mm) wide cast web drawn according to Case A would have this critical value at about 0.7 from the edge. This would fit inside the tenter clip and would not split upon drawing. Various multilayer mirror films may improve runnability using this process disclosure.

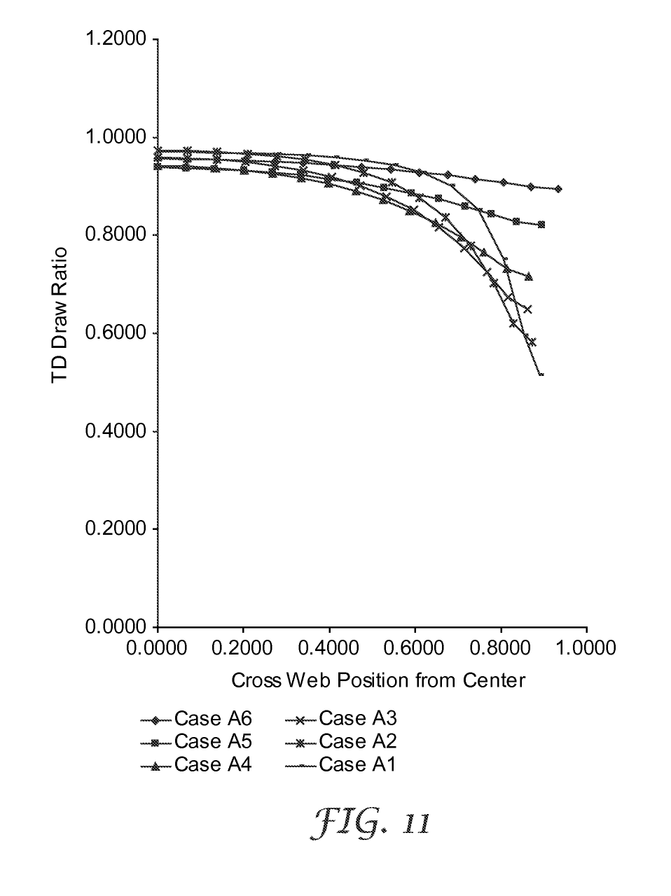

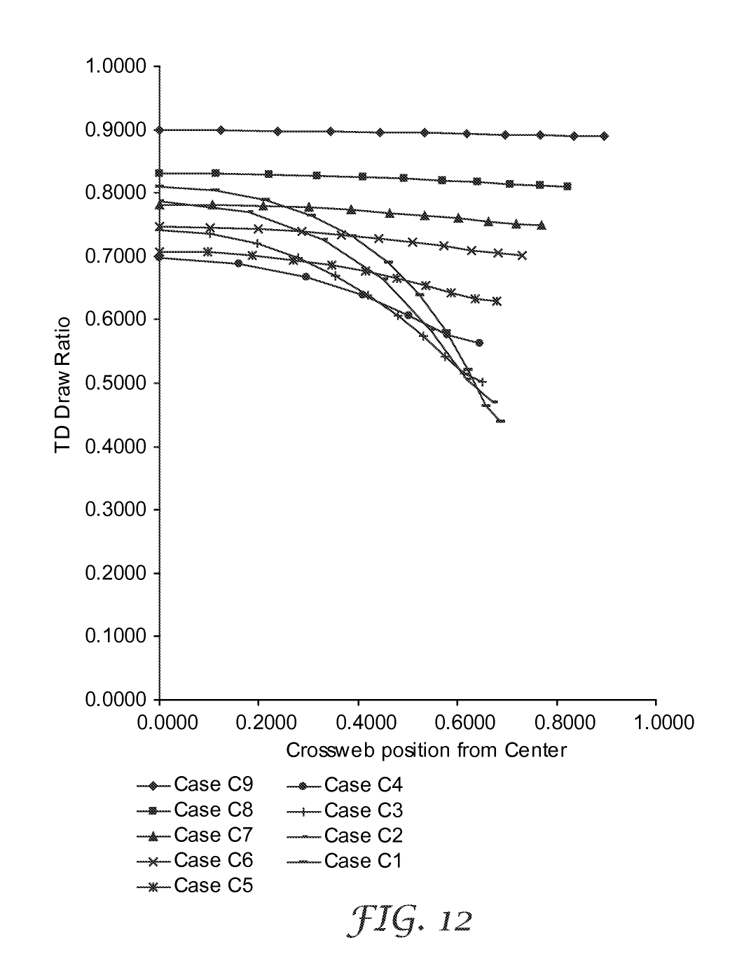

The trend with MD draw ratio is likewise similar and is illustrated in FIGS. 11 and 12 for aspect ratios of 0.4 and 1.6, respectively. These figures demonstrate the sensitivity of the profile with MD draw ratio. Model case A in FIG. 6 is now portrayed in FIG. 11 not only at a draw ratio of 5.0 but also at a variety of much lower draw ratios. In FIG. 11, case A1 corresponds to an MD draw ratio of 5.00; case A2 corresponds to an MD draw ratio of 3.25; case A3 corresponds to an MD draw ratio of 2.50; case A4 corresponds to an MD draw ratio of 2.00; case A5 corresponds to an MD draw ratio of 1.50; and case A6 corresponds to an MD draw ratio of 1.25.

It is clear that there exists a small enough MD draw ratio to bring this low aspect ratio into the uniaxial regime. For example, for an MD draw ratio of 1.25, the limiting width reduction for the uniaxial regime is 0.8944 (=1/(1.25^{0.5})) and the limiting neckdown is thus 10.56%. As discussed above, to fall within the uniaxial regime, the actual neckdown reduction in an exemplary embodiment is at least 80% of the maximum neckdown, which in this case would be 0.8×10.56%=8.4%. The neckdown for Case A6 appears to fall within or close to this uniaxial regime. Thus, for an aspect ratio of 0.4, an MD draw ratio of 1.25 or less appears to bring the case into the uniaxial regime.

FIG. 12 portrays model case C at various draw ratios. Case C1 corresponds to an MD draw ratio of 5.50; case C2 corresponds to an MD draw ratio of 5.00; case C3 corresponds to an MD draw ratio of 4.00; case C4 corresponds to an MD draw ratio of 3.25; case C5 corresponds to an MD draw ratio of 2.50; case C6 corresponds to an MD draw ratio of 2.00; case C7 corresponds to an MD draw ratio of 1.75; case C8 corresponds to an MD draw ratio of 1.50; and case C9 corresponds to an MD draw ratio of 1.25. From the data, it can be seen that there is a “turning point” where the neckdown reverses as the MD draw ratio increases, so that the film becomes wider with increasing draw ratio. In this case, the turning point appears to be at a draw ratio between 2.50 and 4.00 (intermediate cases C5 and C3). Other studies have suggested that the neckdown reversal phenomenon may occur at higher MD draw ratios for wider initial films. FIG. 12 suggests that there exists a high enough draw ratio, greater than 5.5, to bring this case into the planar extension regime, where the neckdown is less than about 20%.

For a given aspect ratio, a deeper penetration into the planar extension regime may be achieved by increasing the draw ratio. The same throughput may be achieved by decreasing the casting speed accordingly. This lowering of the draw rate may be combined with increased heating in the draw gap to provide the same level of MD orientation, which can be measured by the MD refractive index. In a PEN:PMMA multilayer film, the increased temperature during draw may more than compensate for the higher draw ratio. In such an example, the total level of orientation achieved by an amorphous polymer is more a function of the Weissenberg number (the product of a longest relaxation time multiplied by the strain rate), than it is a function of the total strain or draw ratio. The longest relaxation time strongly decreases with temperature. Below a critical Weissenberg number, accumulation of orientation is low.

The nominal initial strain rate can be estimated as the change in the draw ratio divided by the time used for drawing. For processes with large changes in strain rate, the change in draw ratio needed to achieve strain-induced crystallization, (for example, the initial draw ratio is 1; however, if a draw ratio of 2 is needed for strain-induced crystallization of some polyesters, then the change in draw ratio needed is 2−1=1) and the time used to achieve strain-induced crystallization may be more appropriate. In a length orienter, the nominal initial strain rate can be estimated as the change in the draw ratio times the linear speed of the slow roll of a given gap, divided by the effective length of that gap. Typically, rates are 0.1, 1 or 10 sec⁻¹ or more.

The two regimes: the uniaxial regime and the planar extension regime may be used together in processes involving multiple length orientation steps to provide a final film of good crossweb uniformity. For example, a pre-heating step with low levels of drawing in the uniaxial regime may be followed by a major draw step in another draw gap in the planar extension regime. In this case, the level of neckdown would be greater than anticipated solely by the planar extension regime.

In general, at high temperatures or low strain rates, polymers tend to flow when drawn like a viscous liquid with little or no molecular orientation. At low temperatures and/or high strain rates, polymers tend to draw elastically like solids with concomitant molecular orientation. A low temperature process is typically above but near the glass transition temperature (T_{g}) of an amorphous polymeric material, e.g. within about 10 to about 20 degrees C. A high temperature process is usually substantially above the glass transition temperature, for example above 40 degrees C. or more. Generally, the higher the molecular weight of the material, such as estimated by I.V., the higher the temperature need to achieve this high temperature regime.

The general trade-off between temperature and rate is generally well known as the time/temperature superposition principal. Quiescent crystallization creating haze can interfere with the application of this principal at sufficiently high temperatures. For polyesters, examples of effective low temperature/high draw rate combinations include 10 degrees above T_{g} at 0.1 sec⁻¹, or 20 degrees above T_{g} at 1 sec⁻¹, for PEN with an I.V. around 0.5 dL/g or PET with an I.V. around 0.75 dL/g or with coPENs of intermediate I.V. between these. Generally, relaxation times increase roughly with a 4^{th} or 5^{th} power in I.V. and rates need to concomitantly decrease.

Under typical conditions in an L.O., at least one continuous material in a layer is drawn under conditions that are orienting, such as in a low temperature process. In such cases, the simulation describing a visco-elastic solid has a basis that can be used to understand the present method described. The equivalency of drawing conditions for normalized crossweb caliper profiles portrayed by FIG. 9 can be used to provide guidelines for process settings. From the cases described in FIG. 9, a rough guideline can be extracted to find other roughly equivalent conditions. In particular, there is a trade-off between draw ratio and aspect ratio of the heated draw gap. A particularly useful quantity derived from the draw ratio is the so-called Hencky strain, conventionally described as the natural logarithm of the draw ratio. Using this definition, the Hencky strain is approximately 0.0, 0.22, 0.41, 0.81, 1.18 and 1.61, for draw ratios of 1.0, 1.25, 1.5, 2.25, 3.25 and 5.0, respectively. The Hencky strain is a measure of geometrical distortion. The rate of change of Hencky strain with MD progress along the draw (i.e. the derivative of Hencky strain with respect to MD position) is a measure of how much geometrical stretching occurs per unit length. The harder the draw (the higher the draw ratio at fixed gap length), the more the draw is compressed into the earlier portion of the draw.

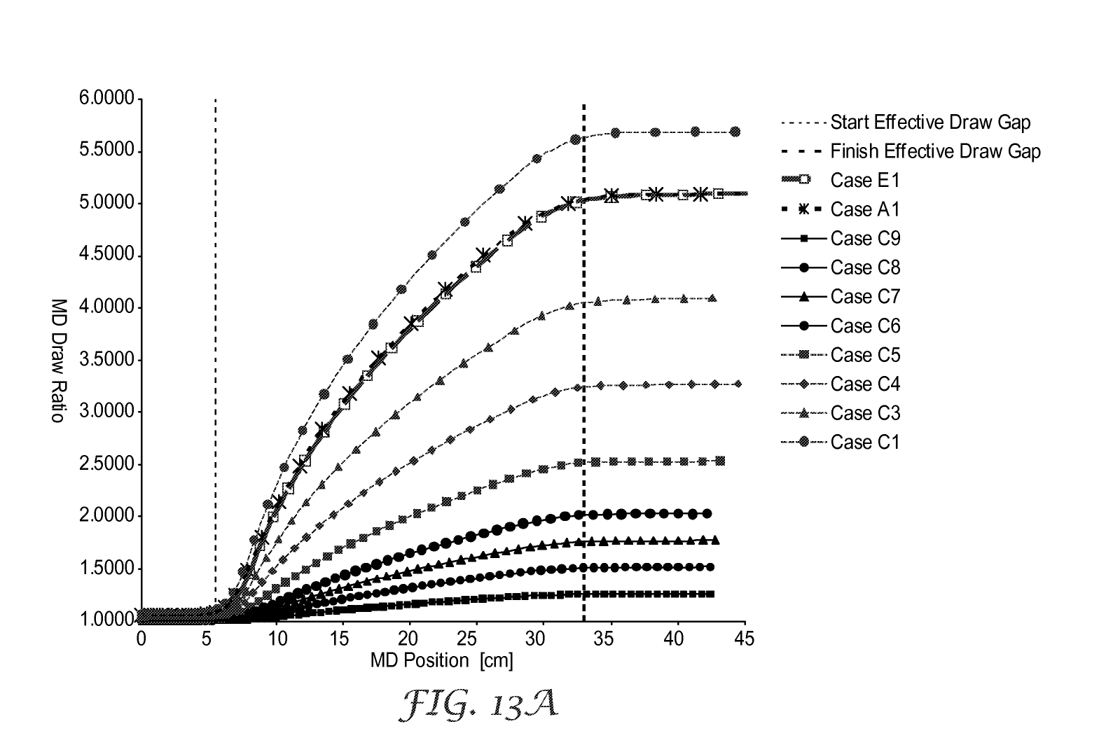

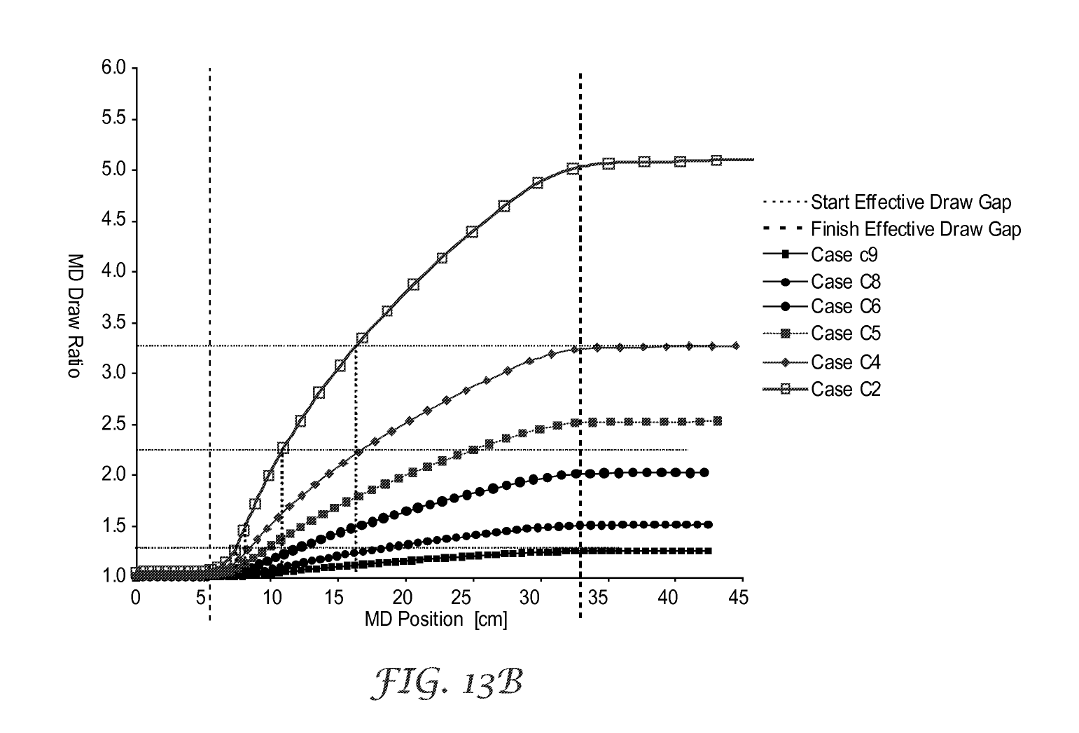

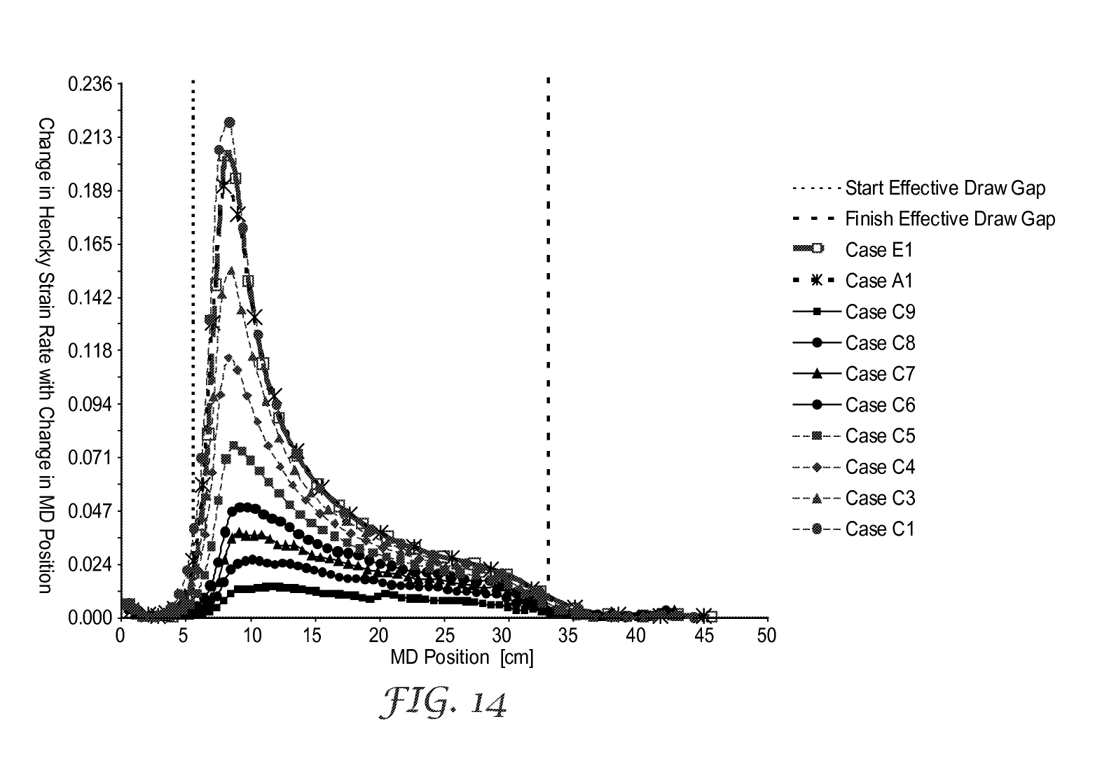

FIG. 13A shows the approximate progress of the draw ratio with MD position in accord with a model simulation, while FIG. 14 shows the rate of change of Hencky strain with MD progress in accord with the same model. FIGS. 13A, 13B and 14 provide an example MD draw gap scale for a case in which the effective draw gap is 27 cm, so that a film about 13 cm wide has an L/W ratio of 2.1 The shape of the these figures can be linearly re-scaled to other physical effective draw gap lengths as needed. For example, the equivalent figures of a film behaving in accord with Case C with an initial draw width of 26 cm would then indicate about a 54 cm effective draw gap along their MD position. Likewise, the dimensioned values of the change in Hencky strain with MD position in FIG. 14 would be halved.

In FIGS. 13A and 14, the cases are the same as in FIGS. 9, 11 and 12. Case C2 is omitted for clarity as it lays atop cases A1 and E1, all taken at the same final draw ratio of about 5. Surprisingly, an interesting pattern emerges for the peak rate of change, or alternatively, for the average rate of change over a small interval about this peak, in which the (average) peak value drops by about a factor of two as one progresses down from draw ratios of 5 to 3.25 to 2.25. The latter value can be discerned implicitly by interpolation between the values at 2.5 and 2.0. The (average) peak value drops by again by a factor of two (slightly more) down to a final draw of 1.5 and then again by a factor of 2 down to 1.25. This region of high change in Hencky strain along MD in the gap is where a significant portion of the MD draw and TD neckdown occur. From a geometrical standpoint, if the length dimension is compressed by a factor of two, then it appears that to maintain a rough equivalency in the neckdown behavior, the width dimension should likewise be reduced by a factor of two. As the rate of (average) peak Hencky strain doubles with increasing draw ratio, then halving the width (e.g. halving the L/W ratio at constant effective draw gap length) roughly compensates and approximately similar crossweb variations across the final width of draw film can be found. Again, this surprising relation is apparent once the position across the width is normalized by the final width and once the thickness is normalized by its center thickness for any given case. This normalization is used to eliminate the confounding variation of final total width and final center thickness among the various draw ratio cases, as performed in FIG. 9.

In many cases, a rule of thumb for finding equivalent conditions of pairs of draw ratio (MDDR) and gap/film aspect ratio (L/W) uses the draw ratio development along the gap. The method is illustrated graphically in FIG. 13B. First, the draw ratio profile along the gap is obtained, regardless of the aspect ratio L/W. For example, the simulation results of FIG. 13B can be used, or a plot for a particular system configuration can be constructed with a video camera and fiducial line marking system. This also provides the length, L, of the effective heated draw gap. This length is about 27 cm in FIG. 13B. Second, a lower draw ratio is chosen and the distance along the MD position is determined at which this MDDR is achieved on the known MDDR profile. The length of the heated draw gap needed to reach this position is then directly determined by subtracting the initial MD position at the start of the effective draw gap. In FIG. 13B, lower draw ratios of 3.25, 2.25, 1.5 and 1.25 have been chosen for discussion purposes, resulting in MD positions of 16.7, 10.9, 8 and 7.1 cm respectively as shown by the construction of the vertical lines dropped from the chosen draw ratios along the MDDR profile curve for Case C2. In turn, these result in effective draw gaps of 11.2, 5.4, 2.5 and 1.6 cm, which decrease roughly by factors of 2 as expected from the description of the previous method. Finally, the relative the L/W ratio needed to approximate the same condition in normalized crossweb caliper profile for any given or chosen L/W at the higher draw ratio is roughly that L/W ratio times the ratio of the MD position at the reduced draw ratio to the MD length of the effective draw gap of at the higher draw ratio. In the examples in FIG. 13B, these ratio factors are 0.41, 0.20, 0.09 and 0.06, for chosen example draw ratios of 3.25, 2.25, 1.5 and 1.25, respectively. These numbers are in rough agreement with the following method using the rate of change of Hencky strain along the draw gap at constant β.

An alternative method for determining equivalent conditions for a process running the same material at the same line speed (which can alter the heating and thus the effective draw gap) can now be presented. Defining H as the Hencky strain, then dH/dx|ₘₐₓ is the peak change with MD position x and <dH/dx|ₘₐₓ> is the average over some reasonable span, e.g. over 10% of the effective draw gap in FIG. 14. Roughly equivalent conditions occur when

dH/dx|ₘₐₓ)(W)=dH/d(x/L)|ₘₐₓ) (L/w)⁻¹=β

where β is a constant of a given value. To achieve a certain level of uniformity, the value of β is in part a function process configuration, the material properties and the property from which uniformity is demanded, whether it is caliper uniformity, refractive index uniformity, extent of uniaxial character or some other property resulting from draw. The various properties will in general hold to this rule of thumb to varying degrees over various ranges of draw ratio and L/W ratio. The caliper uniformity and extent of uniaxial character (and through association, the difference between the TD and ND refractive index) are described herein.

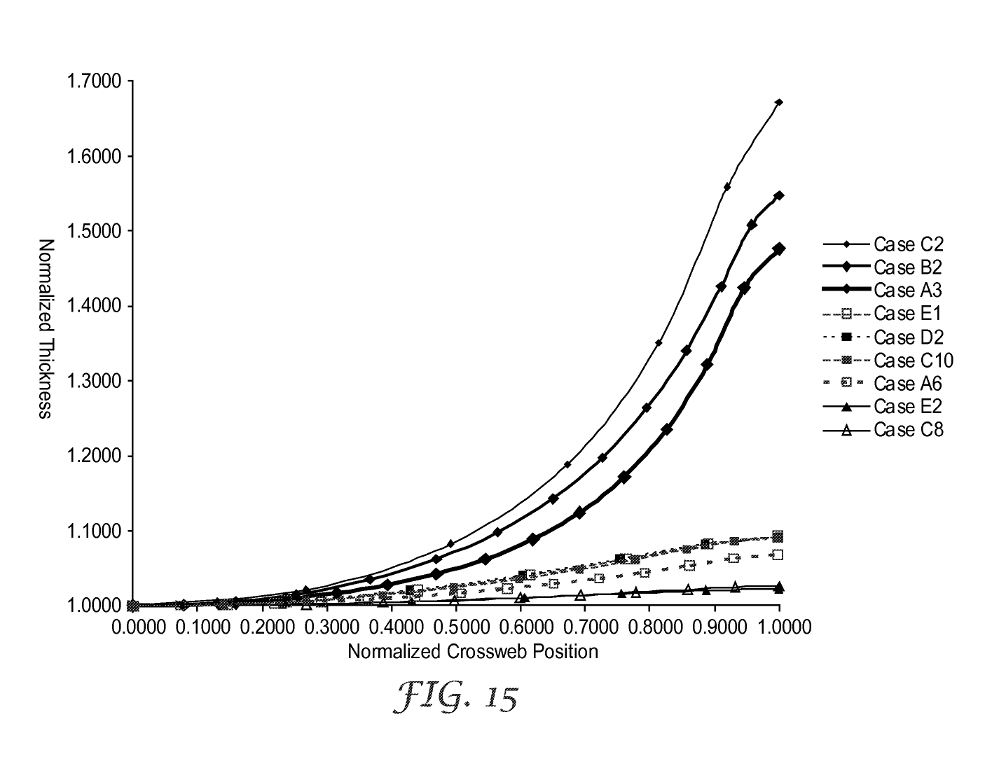

Using the rule of thumb above, a more general set of roughly equivalent conditions than that provided in FIG. 9 can now be provided in FIG. 15. The cases again follow the descriptions of the previous Figures. In addition, case B2 is case B with draw ratio of 3.25. Case C10 is case C with a draw ratio of 2.25. Case C10 is actually an interpolated composite of cases C5 and C6 using a linear interpolation over the Hencky strain. Three roughly equivalent groups of conditions are presented in FIG. 15. The first group including cases C2, B2 and A3 show the results for β around 3. The second group including cases E1, D2, C10 and A6 show the results for β around 0.7. The third group including cases E2 and C8 show the results for β around 0.3. There appears to be a general deviation from the rule of thumb to slightly better uniformity as one proceeds to the lowest draw ratios. Nevertheless, the trends roughly maintain: β should be under 1, preferably under 0.8 to be in the truly uniaxial regime. For example, with these values, the caliper variation is less than 10% across the film or is less than 5% over a 60% central final portion of the film. Also, for these values, the extent of truly uniaxial character, U, is greater than 0.2 across the entire film or greater than 0.7 when the draw ratio is greater than about 1.5 or 2.0. Using the rule of thumb, it follows from the discussion of FIG. 6 that β should be a value of roughly 10.0 or more to put a typical process in the planar extension regime.

In practice, the Hencky strain and change of Hencky strain with MD position can be alternatively measured for materials that can be marked, for example gridded with ink. Lines can be drawn across the TD prior to stretching, such as with an inked, lined roller. The separation of these marks in the drawing process can be recorded, such as by a camera system. Once the 0 value is determined for a given process configuration and material set that provides a particular level of uniformity, the rule of thumb can be used to find reasonably equivalent other conditions without undue experimentation.

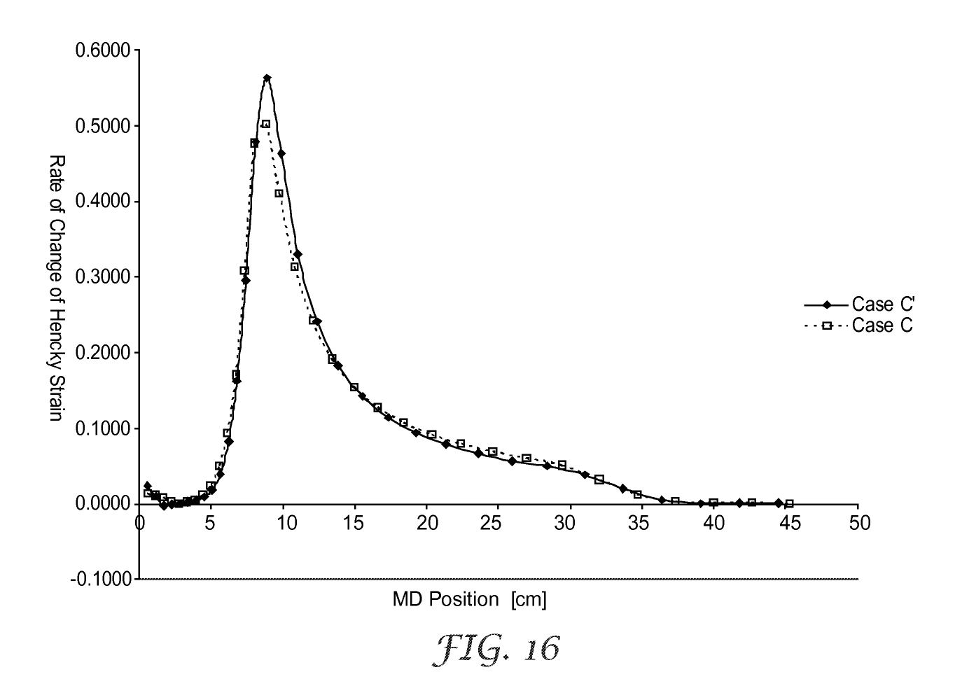

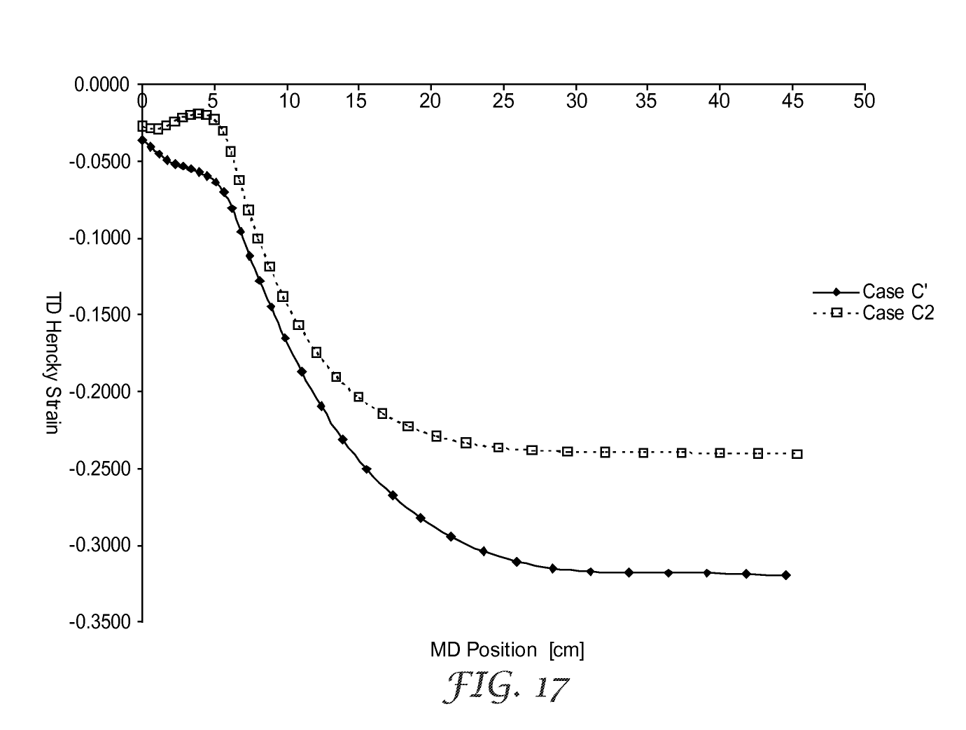

In general, the whole shape of the Hencky strain development along the effective draw gap can impact the uniformity. Generally, conditions that make the initial portion of the draw more gradual improve the approach to the truly uniaxial regime. Returning to Cases C′ and C of FIG. 6 (case C in FIG. 6 is C2 in FIG. 12), the MD Hencky strain ramps a little more slowly for C′ than C2, as shown in FIG. 16, even though the actual peak is higher in C′. What is more important in this case comparison is the response of the TD Hencky strain response. In FIG. 17, Case C′ begins to neckdown earlier in the draw, in the colder heating zone between 0 and 5 cm. Thus, Case C′ demonstrates a lengthening of the effective draw gap, resulting in a larger neckdown for the same nominal geometry. Because the material in the gap is not as soft relative to the initial cold input web, the draw gap becomes effective much earlier in the heating process. Thus, the definition of the effective draw gap has to be considered in the context of both the MD and TD deformation.

The development of stress as a function of draw ratio and other process conditions such as temperature and rate can also affect the progress of the MDDR profile through the draw gap. In the limit of very low draw ratios, the stress may increase linearly with the nominal strain, e.g. Hooke's Law, or the stress may increase linearly with Hencky strain. Many polymeric material systems can be described over larger draw ratio ranges with a Neo-Hookean stress relationship with draw ratio, in which the stress increases linearly with Hencky strain at low draw ratios and gradually transitions to a quadratic relation in draw ratio in the limit of truly uniaxial extension.

As described in the following examples, the model results of the various figures characterize a material system that approximates a Neo-Hookean material in the hottest portions of the heated draw gap. In some material systems, at even higher draw ratios, the stress may increase still faster than the stress would increase in a Neo-Hookean material. Strain hardening typically describes a stress relationship in which the stress increases faster than linearly with strain. Typically, strain hardening tends to concentrate the draw more sharply into an initial portion of the draw. In the lowest draw ratio cases, e.g. case C9 of FIG. 14 and Case A6 of FIG. 15, both at an MDDR value of 1.25, the MD stresses are still essentially linear with strain. In FIG. 14, the changes in the Hencky strain are the most evenly distributed across the effective draw gap. The effect of the stress development can be seen for example by the deviation of case A6 from E1, D2 and C10 in FIG. 15. In general, more severe strain-hardening than that for a Neo-Hookean material will require an increase in L/W when increasing the draw ratio to achieve an equivalent condition relative to the rough rule of thumb provided, and conversely more severe strain hardening will allow a greater decrease in L/W when decreasing the draw ratio relative to the rough rule of thumb. In a similar manner, increasing the draw temperature significantly above the glass transition temperature, e.g. by 20 degrees C. or more, or decreasing the strain rate significantly, will tend to lower the level of molecular orientation and stress and improve the approach to the truly uniaxial regime at a given draw ratio, albeit at a lower level of final in-plane birefringence.

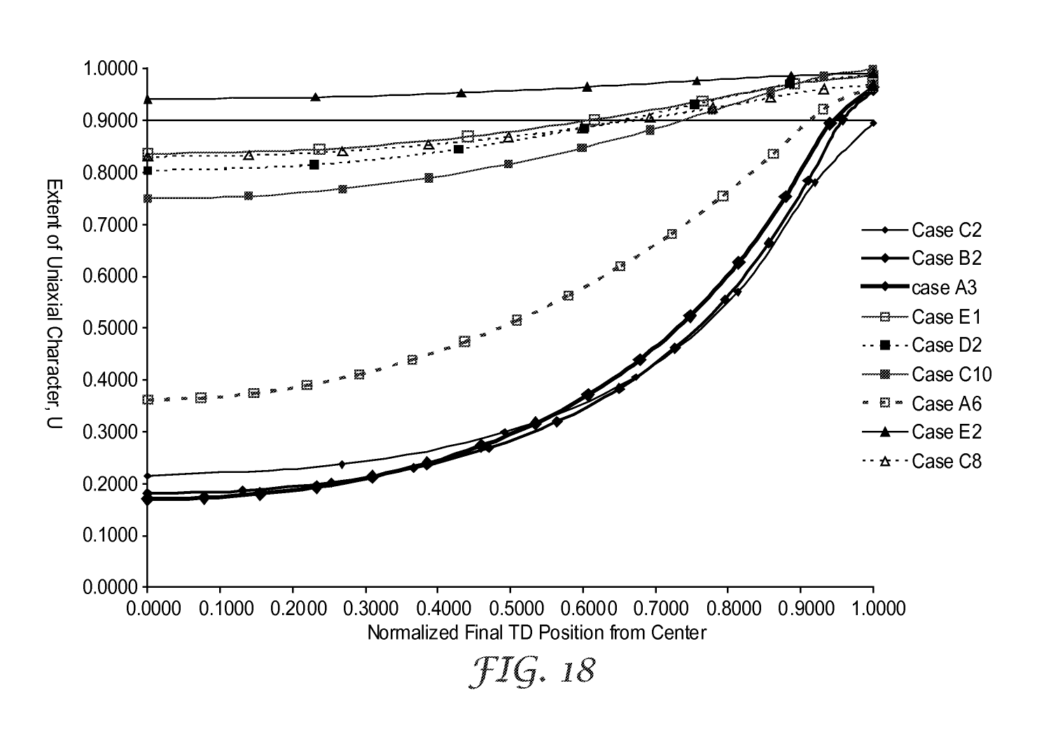

In FIG. 18, the extents of truly uniaxial character as determined by the model draw ratios are presented for groups similar to the cases in FIG. 15. As shown in FIG. 18, the particular behavior of the uniformity of the extent of uniaxial character is different than in FIG. 15 for the caliper uniformity, but the general trends and groupings maintain. However, the extent of uniaxial character, U, is much more sensitive to large widths (low L/W ratios), with diminished U values at the film center, such as in Case A6. Thus, it may be preferred to decrease the draw ratio further than provided by the rough rule of thumb as one decreases L/W. Thus, the extent of uniaxial character can be maintained at a value of 0.7, 0.8, 0.9 or more for the draw ratios of 2 or more that are typically desired for the orientation of optical films, such as those comprising any of the previously described monolithic or blended material layers, especially comprising the polyesters.

To control uniformity, such as uniformity in caliper (thickness) or extent of uniaxial character (U), the draw ratios may be adjusted as previously described. If a particular draw ratio is desired, such as for control of a particular property, then the inlet width or effective draw gap can be altered. In some cases, the inlet width can be adjusted by a change in casting speed. The non-uniformities in casting thickness may then be adjusted in some cases with die lip gap control.

It should be noted that the equivalency discussed with respect to FIGS. 15 and 18 is with respect to the uniformity or character of the properties not the actual amount of those properties. In FIG. 15, the respective groups represent equivalent conditions of thickness or cross-web draw ratio uniformity. In FIG. 18, the respective groups represent similar levels of uniaxial character, U. The amount of orientation and resulting property levels depend upon the draw ratio, temperature, strain rate, etc. For example, it would follow that the conditions with higher draw ratio would have higher levels of index development and birefringence than their equivalent conditions at lower draw ratio, drawn in the same manner.

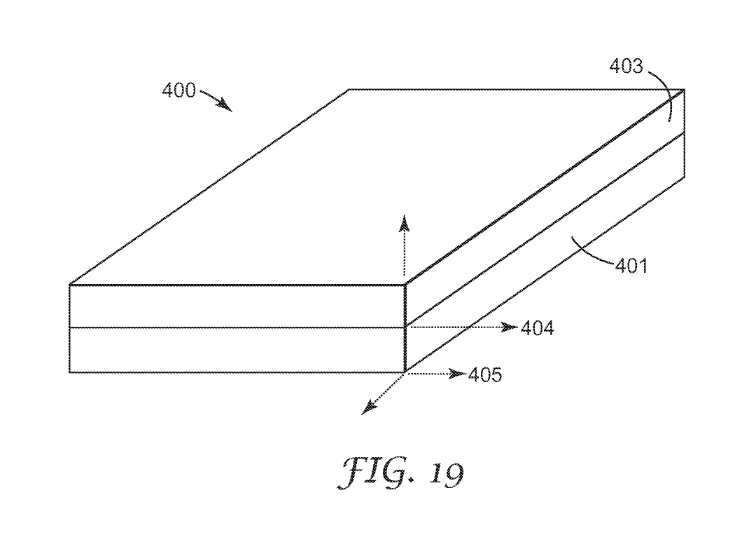

FIG. 19 illustrates an optical film construction 400 in which a first optical film 401, such as a reflective polarizer with a block axis along a direction 405, is combined with a second optical film 403. In one embodiment, a film 20 of the present disclosure is used as first film 401. The second optical film 403 may be another type of optical or non-optical film such as, for example, an absorbing polarizer, with a block axis along a direction 404.

In the construction shown in FIG. 19, the block axis 405 of the reflective polarizing film 401 should be aligned as accurately as possible with the block axis 404 of the dichroic polarizing film 403 to provide acceptable performance for a particular application as, for example, a brightness enhancement polarizer or a display polarizer. Increased mis-alignment of the axes 404, 405 diminishes the gain produced by the laminated construction 400, and makes the laminated construction 400 less useful for display polarizer applications. For example, in an exemplary embodiment of a brightness enhancement polarizer, the angle between the block axes 404, 405 in the construction 400 is less than about +/−10°, is more preferably less than about +/−5°, and is and even more preferably less than about +/−3°.

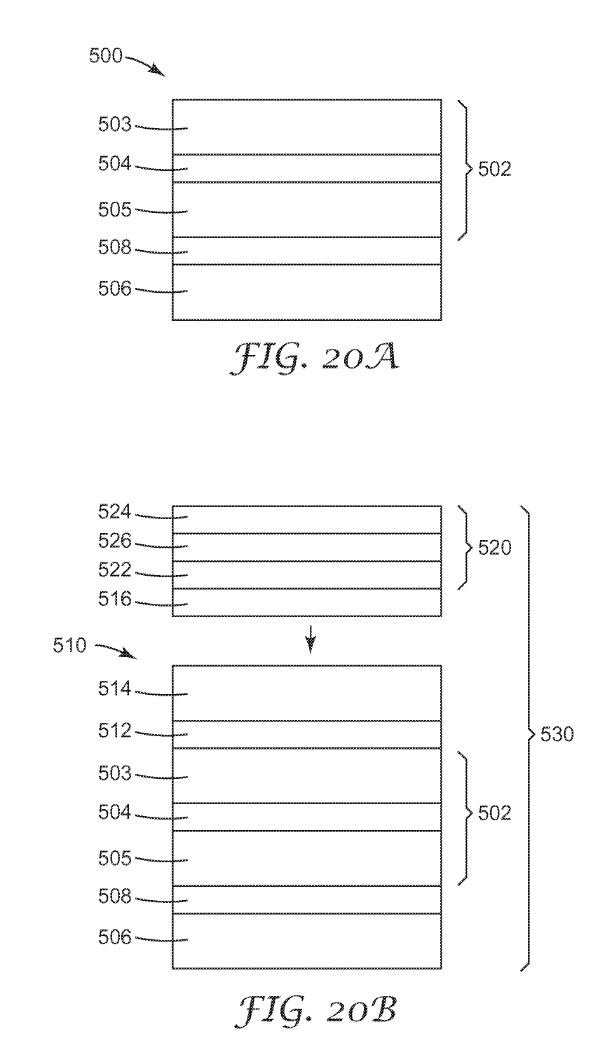

In an embodiment shown in FIG. 20A, a laminate construction 500 includes an absorbing polarizing film 502 with a first protective layer 503. The protective layer 503 may vary widely depending on the intended application, but typically includes a solvent cast cellulose triacetate (TAC) film. The exemplary construction 500 further includes a second protective layer 505, as well as an absorbing polarizer layer 504, such as an iodine-stained polyvinyl alcohol (I₂/PVA). The absorbing polarizing film 502 is laminated or otherwise bonded to or disposed on an optical film reflective polarizer 506 (which can be film 20 as described herein having an MD block axis), for example, with an adhesive layer 508.

FIG. 20B shows an exemplary polarizer compensation structure 510 for an optical display, in which the laminate construction 500 is bonded to an optional birefringent film 514 such as, for example, a compensation film or a retarder film, with an adhesive 512, typically a pressure sensitive adhesive (PSA). In the compensation structure 510, either of the protective layers 503, 505 may optionally be replaced with a birefringent film that is the same or different than the compensation film 514. Such optical films may be used in an optical display 530. In such configurations, the compensation film 514 may be adhered via an adhesive layer 516 to an LCD panel 520 including a first glass layer 522, a second glass layer 524 and a liquid crystal layer 526.

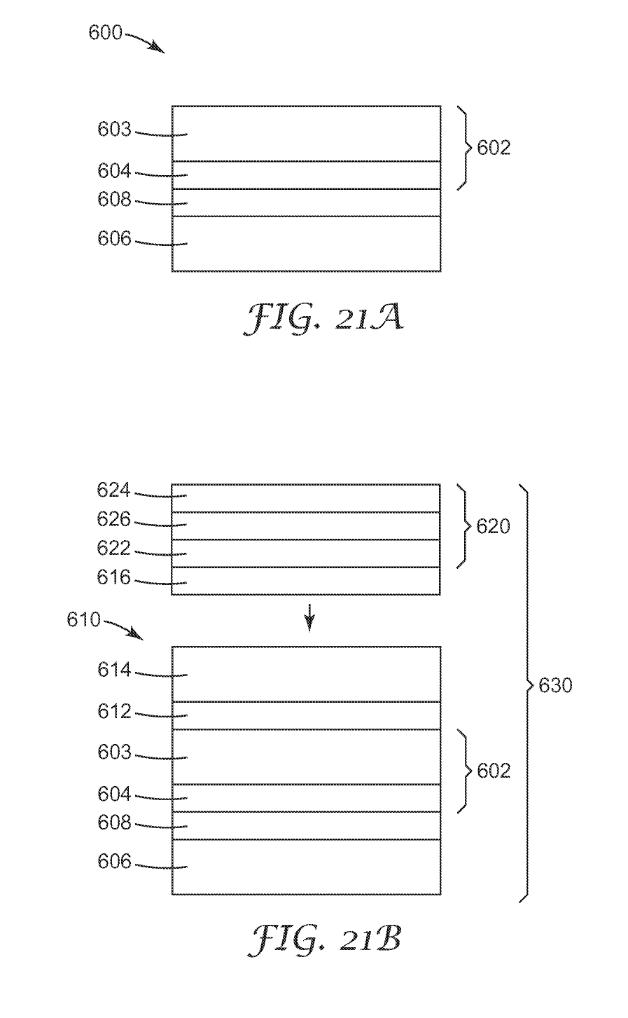

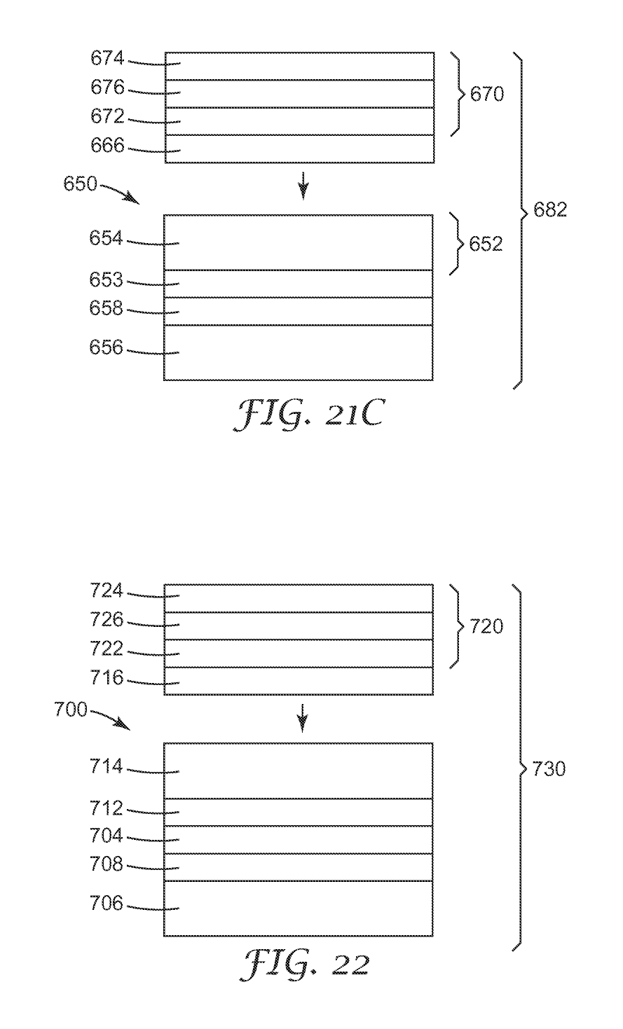

Referring to FIG. 21A, another exemplary laminate construction 600 is shown that includes an absorbing polarizing film 602 having a single protective layer 603 and an absorbing polarizing layer 604, e.g., a I₂/PVA layer. The absorbing polarizing film 602 is bonded to an MD polarization axis optical film reflective polarizer 606 (which can be film 20 as described herein having an MD block axis), for example, with an adhesive layer 608. In this exemplary embodiment, the block axis of the absorbing polarizer is also along the MD. Elimination of either or both of the protective layers adjacent to the absorbing polarizer layer 604 can provide a number of advantages including, for example, reduced thickness, reduced material costs, and reduced environmental impact (solvent cast TAC layers not required).

FIG. 21B shows a polarizer compensation structure 610 for an optical display, in which the laminate construction 600 is bonded to an optional birefringent film 614 such as, for example, a compensation film or a retarder film, with an adhesive 612. In the compensation structure 610, the protective layer 603 may optionally be replaced with a birefringent film that is the same or different than the compensation film 614. Such optical films may be used in an optical display 630. In such configurations, the birefringent film 614 may be adhered via an adhesive layer 616 to an LCD panel 620 including a first glass layer 622, a second glass layer 624 and a liquid crystal layer 626.

FIG. 21C shows another exemplary polarizer compensation structure 650 for an optical display. The compensation structure 650 includes an absorbing polarizing film 652 with a single protective layer 653 and an absorbing polarizer layer 654, such as a I₂/PVA layer. The absorbing polarizing film 652 is bonded to an MD block axis reflective polarizer 656 (which can be film 20 as described herein), for example, with an adhesive layer 658. In the compensation structure 650, the protective layer 653 may optionally be replaced with a compensation film. To form an optical display 682, the absorbing polarizer layer 654 may be adhered via adhesive layer 666 to an LCD panel 670 including a first glass layer 672, a second glass layer 674 and a liquid crystal layer 676.

FIG. 22 shows another exemplary polarizer compensation structure 700 for an optical display, in which the absorbing polarizing film includes a single absorbing (e.g., I₂/PVA) layer 704 without any adjacent protective layers. One major surface of the layer 704 is bonded to an MD block axis optical film reflective polarizer 706 (which can be film 20 as described herein having an MD block axis) such that the block axis of the absorbing polarizer is also along MD. Bonding may be accomplished with an adhesive layer 708. The opposite surface of the layer 704 is bonded to an optional birefringent film 714 such as, for example, a compensation film or a retarder film, with an adhesive 712. Such optical films may be used in an optical display 730. In such exemplary embodiments, the birefringent film 714 may be adhered via adhesive layer 716 to an LCD panel 720 including a first glass layer 722, a second glass layer 724 and a liquid crystal layer 726.

The adhesive layers in FIGS. 20-22 above may vary widely depending on the intended application, but pressure sensitive adhesives and H₂O solutions doped with PVA are expected to be suitable to adhere the I₂/PVA layer directly to the reflective polarizer. Optional surface treatment of either or both of the reflective polarizer film and the absorbing polarizer film using conventional techniques such as, for example, air corona, nitrogen corona, other corona, flame, or a coated primer layer, may also be used alone or in combination with an adhesive to provide or enhance the bond strength between the layers.

In an exemplary embodiment, an optical film comprising a polyester or co-polyester with at least some PET-like or PEN-like moieties, such as terephthalate or naphthalate based sub-units along the chain axis, is formed by drawing the film in one in-plane direction while maintaining or reducing the breadth in the perpendicular in-plane direction to make at least one polyester birefringent and then further heating the drawn film above the initial or final drawing temperatures in a manner that allows at least a further 10% reduction in breadth. In some cases the breadth reduction can be 20% or more.

In another exemplary embodiment, an optical film comprising a polyester or co-polyester with at least some PET-like or PEN-like moieties, such as terephthalate or naphthalate based sub-units along the chain axis, is formed by drawing the film in one in-plane direction while maintaining or reducing the breadth in the perpendicular in-plane direction to make at least one polyester birefringent and then further heating the drawn film above the initial or final drawing temperatures in a manner that maintains or decreases the relative birefringence of at least one birefringent polyester. The relative birefringence obtained in this manner can be under 0.2, 0.15 or even below 0.10.

In still another exemplary embodiment, an optical film comprising a polyester or co-polyester with at least some PET-like or PEN-like moieties, such as terephthalate or naphthalate based sub-units along the chain axis, is formed by drawing the film in one in-plane direction while maintaining or reducing the breadth in the perpendicular in-plane direction to make at least one polyester birefringent and then further heating the drawn film above the initial or final drawing temperatures in a manner that improves the crossweb draw ratio or caliper profile over an edge portion of the film. The edge portion may be on the order of a few to 10 centimeters or more on each side, or encompass 10%, 20% or more of each side of the film.

In yet another exemplary embodiment, an optical film comprising a polyester or co-polyester with at least some PET-like or PEN-like moieties, such as terephthalate or naphthalate based sub-units along the chain axis, is formed by drawing the film in one in-plane direction while maintaining or reducing the breadth in the perpendicular in-plane direction to make at least one polyester birefringent so that the refractive index for light polarized along the draw direction is below a critical value that allows for breadth reduction in a further heated step.

If the film is drawn along MD, then the breadth is the TD direction and vice versa. In exemplary embodiments, the optical film can comprise a multi-layer film with alternating layers of two different materials, a multi-layer optical film with three or more layers of different materials in at least some type of repeating pattern, a continuous/disperse blend or bi-continuous blend with a continuous polyester phase, or any combination of these. Particularly useful examples of such polyesters include PET, PEN and the coPENs which are random or block co-polymers of intermediate chemical composition between PET and PEN.

The drawing conditions that allow the breadth reduction upon orientation depend on the processing temperature history, strain rate history, draw ratios, molecular weights (or IV of the resin) and the like. Typically, it is desired that the film be drawn sufficiently to initiate strain-induced crystallization but not so much as to cause high levels of crystallinity. For exemplary effective draws near the glass transition temperature, the draw ratio typically is under 4, more typically under 3.5, or even 3.0 or less. Typical temperatures are within 10 degrees C. above the glass transition temperature for typical initial draw rates of 0.1 sec⁻¹ or more. For higher temperatures, higher rates are typically used to maintain the same level of effective drawing. Alternatively, higher draw ratios may be allowed. The level of breadth reduction for a film as a function of orientation in a continuous phase may also be altered by the extent and nature of a dispersed or bi-continuous phase.

Another method for determining the level of draw is to measure the effectiveness of that draw on the resulting refractive indices. Above a critical draw index for a given polyester resin, the breadth reduction becomes slight, for example below 10%. Below this critical draw index, significant breadth reduction can occur in a subsequent step, given sufficient time, heating and relaxation of constraints. In many cases, the relative birefringence can also be reduced with the breadth reduction step. For a coPEN comprising 90% PEN-like moieties and 10% PET-like moieties, the critical draw index at 632.8 nm is between 1.77 and 1.81. A best estimate is about 1.78. The critical draw index for PEN is less than 1.79 and probably similar to the value for the 90/10 coPEN. A rough estimate for PET is between 1.65 and 1.68. As a first approximation, coPEN values can be estimated as roughly increasing from the PET values to the PEN values as the coPEN increasingly becomes more like PEN in chemical composition. However, since the level of crystallinity at a given draw index may impact the ability for structural re-arrangement, it may be expected that coPEN critical index values may be higher than these first approximations, as may be indicated from the comparison between the coPEN 90/10 and pure PEN estimates. In general, critical values can be found by heat setting drawn samples of measured index values mounted to provide a large L/W ratio where L is along the direction of draw, and observing the cross-draw width reduction after heat setting. Finally, it should be noted that the critical values may change with severe changes in temperature, such as by heat setting at temperatures near the melting point.

An L.O. can be particularly useful in achieving such drawing conditions while maintaining a reasonably uniform draw ratio along the stretching direction (MDDR in the cases of an L.O.). Cross-drawn films, e.g. as drawn in a tenter or a batch stretching device, may be prone to more draw ratio non-uniformities along the stretching direction (TDDR in these case) and thus more product non-uniformities due to cross-web temperature variations and the like. Thus, a particularly useful process uses an L.O. to provide at least the initial drawing step prior to breadth reduction.

The breadth reduction step is accomplished in a manner so that the film can pull-in across its breadth perpendicular to the direction of the first drawing step. When the breadth reduction step is accomplished across a draw gap of an L.O., the L/W ratio is important in controlling the extent and uniformity of the breadth reduction. An L/W ratio of at least 1 is typically desired. Values of 5, 10 or more can be used. It may be useful to use the lowest allowable L/W that achieves the desired breadth reduction to minimize flutter and wrinkling The temperature and time are preferably of sufficient amount and extent to allow the strain recoil in the process step. Typical conditions for the breadth reduction step comprise heating the film above the glass transition temperature of each continuous phase material in the construction for at least one second. More typically, the heating is to at least the average temperature of the drawing step for at least the time used to accomplish the draw step. In other cases, the temperature of the film is more than 15 degrees C. above the glass transition temperature of each continuous phase material in the construction for 1, 5, 15, 30 seconds or more.

The breadth reduction step may result in a leveling of the thickness due to uneven neck down during the first drawing step. Likewise, a more level distribution of the cross-breadth draw ratio (e.g. TDDR for a film drawn along MD) across the breadth of the film may be achieved as well as a more consistent extent of uniaxial character across the film. In this manner, a more uniform film can be formed. Thus, in one embodiment, the disclosure describes a low draw ratio process with additional heat setting to create breadth reduction and improved uniaxial character regardless of the stretch direction.

The breadth reduction step may also result in an increase in the haze level. Generally, the closer to the critical index, the less the haze increase. In some applications, the level of heat treatment with its reduction in relative birefringence can be balanced against increases in haze as a function of the use of the film so formed for a given optical application.

The following examples include exemplary materials and processing conditions in accordance with different embodiments of the disclosure. The examples are not intended to limit the disclosure but rather are provided to facilitate an understanding of the invention as well as to provide examples of materials particularly suited for use in accordance with the various above-described embodiments.

### Example 1

### Length Orienter Multilayer Film Comprising CoPEN and PMMA

A precursor of a multilayer optical film was cast as described in U.S. Pat. No. 6,830,713, incorporated herein by reference, and subsequently drawn to various draw ratios in a length orienter. The multilayer cast web comprised the 90/10 coPEN with alternating layers of PMMA in the optical layers. The skin layer comprised a high index birefringent material, a so-called 90/10 coPEN co-polymer with 90 mol % PEN-like moieties and 10% PET-like moieties, allowing direct measurement of the refractive indices.

The film was cast with a non-flat thickness profile in order to compensate for thickness variations with draw processing to obtain a final, relatively flat optical film. The methods of the present disclosure allow for improved thickness (caliper) and property uniformity transversely across the film. Some methods of film casting allow profiled thicknesses that may counter-balance the non-uniformities developed during drawing, e.g. in a length orienter; however, the basic non-uniformity in properties such as refractive index remain. Further improvements in thickness uniformity may be achieved by combining cast thickness profiling with the present methods. Likewise, film results using these combinations, such as those provided in Example 2, clearly lie within the intended scope of the present disclosure.

The cast web was drawn in an L.O. to form the drawn precursor optical film, hereafter referred to as the “L.O.ed film.” The L.O.ed film would normally be drawn to a desired MDDR and then further drawn transversely, e.g. in a tenter, to form a multilayer optical mirror film as described by Jonza et. al. in U.S. Pat. No. 5,882,774. The cast web example film thus made is referred to as Case F1.

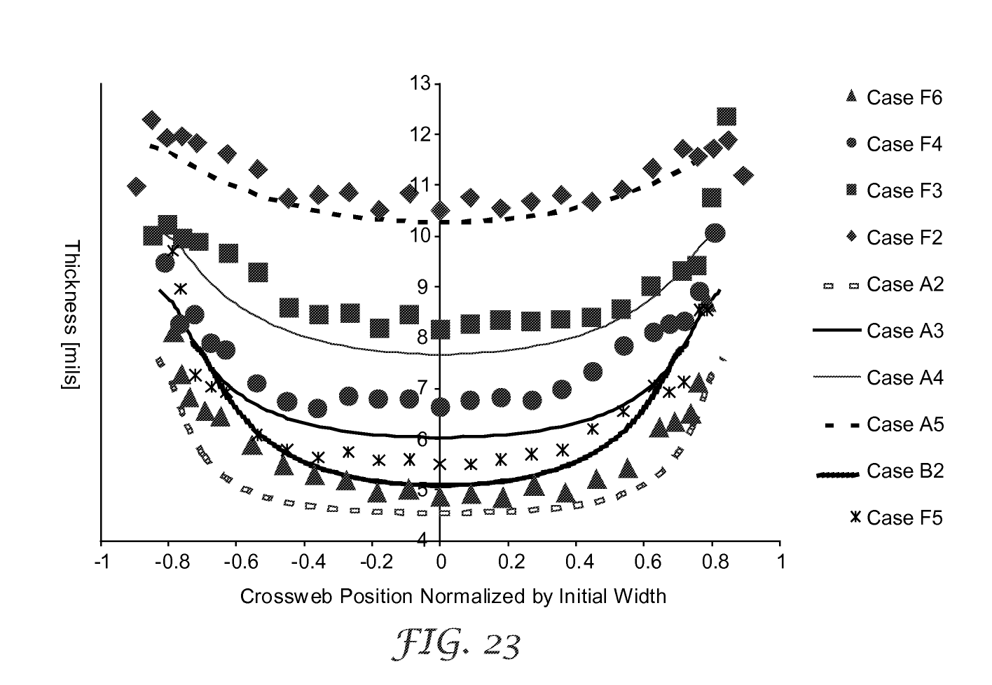

Different samples of the film were drawn using a length orienter with a heated draw gap to draw ratios (MDDR) of approximately 1.5, 2.0, 2.5, 3.0 and 3.3, to form example Cases F2, F3, F4, F5 and F6 respectively. The film was pre-heated with contact rollers, conveyed over a final slow roll into a draw gap, heated by infra-red heaters to just above the glass transition temperature of the coPEN, drawn in the gap and then quenched on the fast, chilled roll. The draw ratio was principally set by the relative speed ratios of the fast to slow rolls. (The film was very slightly tensioned through the initial pre-heat.) The ratio of the heated draw gap to the width of the film was estimated to be roughly about 0.4 (L/W), similar to model case A. With this single estimate setting the geometrical parameter for the theoretical model, the modeling results, shown in FIG. 23 were compared to the films drawn in accordance with this example. Moreover, the film of Case F5 was further used in the following Example 2 describing post-draw heat setting.

The comparison shows reasonable agreement, although the details of the material system appear to shift the results mid way between cases A and B. For example, the experimental results at a draw ratio of 3.25 lie intermediate between the model results of Cases A and B. According to the present method, the basic scaling relationships between the geometrical aspects of the process should roughly maintain. It is recommended that a calibrating experiment be used to account for the material variations for a given geometrical configuration. In this respect, a 50% increase in absolute estimate of L/W may be warranted due to material effects. In this way, although the L/W ratio becomes more a parameter within the method that may vary modestly from the actual geometrical factor, the L/W ratio can incorporate both the actual geometrical aspects and certain aspects of the material factors, so that the general methods described herein can be applied.

The model results were re-scaled to the thickness of the initial experimental cast web at its centerline value to allow comparison. To simply account for a 10% pre-stretch in the pre-heating, zone, the initial caliper and web width were adjusted downward each by half this amount. Alternatively, the pre-stretch could be accounted for as a second stretching.

To account for the non-flat initial thickness, the thickness profile of the experimental data after drawing was mapped across TD using a mass balance based on the cumulative film cross section from an edge. The measured actual thickness was then divided by the ratio of the initial thickness of the film as mapped to the current location on the drawn film to the initial thickness of the film in the center of the cast film. In this way, the non-flat initial thickness profile of the cast film was removed from the comparison with the theoretical modeling calculations. The theoretical model and actual experiment thus agree well regarding the extent of overall cross-web final width as well as with the developed thickness profile (as anticipated from a uniformly flat cast film) as a function of draw.

Using the MDDR as set by the process inlet and outlet roll speeds; the TDDR as estimated by the cast to drawn mass balance mapping; and the NDDR as calculated by the ratio of the final to initial cast thickness (as mapped across TD); the extent of uniaxial character was estimated using the formula

U=(1/TDDR−1)/(MDDR^{0.5}−1)

which is analogous to the formula provided for a transverse draw in U.S. Pat. No. 6,939,499, hereby incorporated by reference. The small variation in density with drawing and crystallization was estimated to be negligible (e.g. less than 2%) and thus ignored.

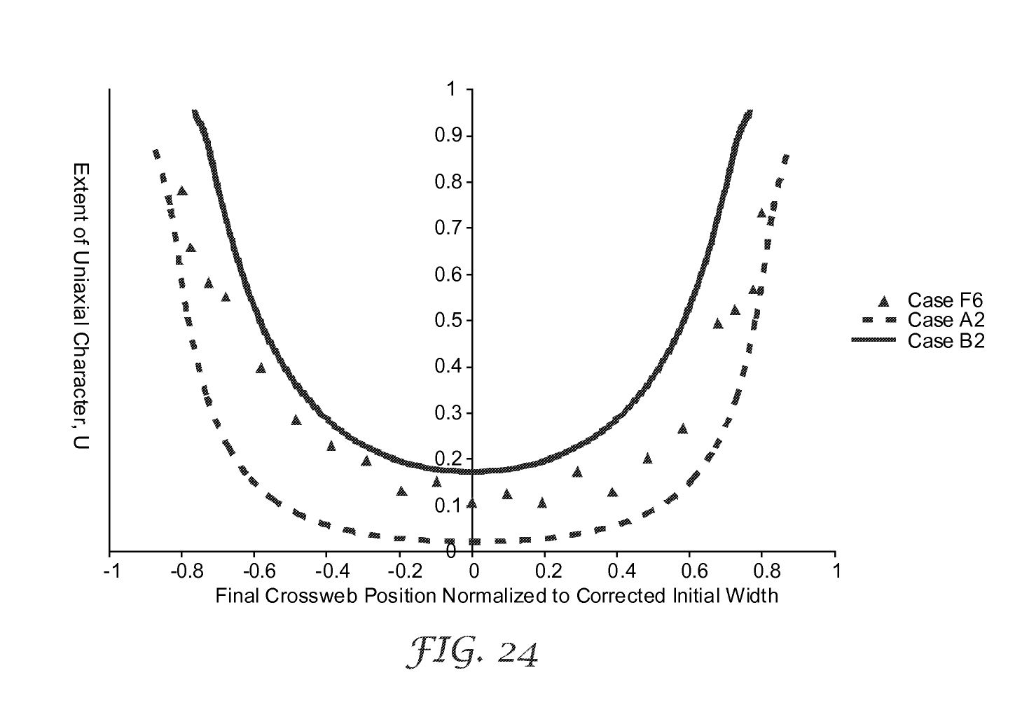

FIG. 24 is a graph illustrating the uniaxial character for an exemplary film with an aspect ratio of L/W=0.4, drawn to an MDDR of 3.3, Case F6. This is compared to the model Cases A2 and B2 in accord with FIG. 23. Again, the initial cast web was corrected for a 5% pre-stretch in both thickness and width and the model curves compressed in the crossweb position by this 5% to show the actual final positions relative to the actual initial cast web positions.

### Example 2

The film drawn to an MDDR of 3.0 from Example 1 above forms the basis for a series of cases in this Example 2. Case 1 is the L.O.-drawn film. Cases 2 through 5 explore the effect of heat setting this film under a variety of conditions. In each Case 2-5, the film was nominally heat set at 175 degrees C. over a 2 minute interval in a laboratory stretching device. The device grips the film at distinct clips whose spacing can be adjusted in-plane. Only one-half of the L.O.-drawn film was studied from one TD edge to nearly the center of the film. To facilitate mounting, the films were cut into two pieces across TD, one covering the edge quarter and the other covering the interior quarter nearly up to the film center. The cases were meant to simulate a variety of conditions that could also be accomplished on-line using a variety of processing equipment.

In Case 2, the film was mounted under a very slight initial MD tension so that the TD edges were unconstrained. In Case 3, the film was mounted as in Case 2 and then further drawn over the course of heat setting by a factor of 1.1 to a final draw ratio of approximately 3.3. Case 4 was the analogue to Case 2 in which the film was mounted so that the TD edges were gripped, thus constraining the TDDR to nearly its initial value before heat setting. Case 5 was the analogue to Case 3 in which the film was mounted so that the TD edges were gripped, thus constraining the TDDR to nearly its initial value before heat setting, while the film was further drawn over the course of heat setting by a factor of 1.1 to a final draw ratio of approximately 3.3.

Prior to heat setting, the films were marked with fiducial lines to allow for direct measurement of draw ratio changes with heat setting. In each case, the refractive indices were measured at selected crossweb (TD) positions using a Metricon Prism Coupler equipped with a He—Ne laser for measurement at 632.8 nm as available from Metricon located in Piscataway, N.J., USA. The skin layer with the 90/10 coPEN on the side contacting the slow roll was measured for the index evaluations. The x, y and z directions correspond to the MD, TD and thickness directions in each case.

Case 1 exhibits the general index trends with varying extent of uniaxial character across the film. The edges have a high degree of uniaxial character due to neckdown, while the low L/W ratio constrains the center of the film. In particular, the edge demonstrates a value of U equal to 0.75 with an index mismatch TD to ND of slightly over 0.01 and a relative birefringence of about 0.066. Case 1 is the baseline for each of the other cases.

In each of the Cases 2-5, a significant increase in the MD refractive index is observed ranging from a difference of 0.01 to almost 0.05. The two Cases 3 and 5 with drawing during heat setting provided the greatest increase in MD refractive index. The added increase in index is typical of what is expected with the increase in draw ratio. Case 3 however showed a very small increase in the difference between the TD and ND indices relative to Case 1, while Case 5 showed the greatest differences. The effect on TD/ND index differences of heat setting under TD constraint without further drawing, exemplified by Case 4, is intermediate in result between Cases 2 and 3 (smallest changes) and Case 5 (largest change).

Case 2 shows the result of heat setting unconstrained in TD, except by the action of the MD boundary condition of clip gripping in the laboratory device. In this manner, the TD edges of the heat set film are particularly able to contract along TD to obtain the highest levels of TD strain recovery across the sample. Since Case 2 was accomplished by two pieces cut at the relative position of 0.43 in TD, the edge measurements at relative positions of 0.37, 0.48 and 0.80 showed the highest level of TD strain recovery, in these cases resulting in a reduction (or at least maintenance within experimental error) in the relative birefringence. A very small strain recovery occurs at the edge corresponding to the edge of the L.O.-drawn film, as would be expected from the high value of U. This location also experiences a maintenance or reduction of relative birefringence with heat setting. The affect of TD strain recovery is also present in Case 3. Thus, TD strain recovery during heat setting can improve the extent of uniaxial character after drawing for films drawn along MD. More generally, strain recovery in a second non-drawn in-plane direction can improve the extent of uniaxial character after drawing in a first in-plane direction (e.g. MD strain recovery if drawn in TD).

In each case in Tables 2-5, the film was heat set under mounting conditions providing an L/W ratio of about 0.8. Under these conditions, breadth reduction over 10% was achieved; however the film still substantially deviated from the conditions of a perfectly truly uniaxial draw over major portions of the film.

Considering Case 2 of this Example 2, relative birefringence was reduced at the very edges of the film, either where the film was already very nearly truly uniaxially oriented, i.e. at position 0.5, or where substantial local breadth reduction occurred at positions 3.5, 4.5 and 7.5. These are the edge positions formed by cutting the original film longitudinally before heat treating. A similar situation occurs in Case 3, except that the highly uniaxial edge at position 5 now has a slight increase rather than a decrease in relative birefringence.

Case 2 of this Example also demonstrates an improvement in the TDDR and likewise the caliper or thickness uniformity through the breadth reduction step. As is directly calculable from the U values in Table 2, the TDDR over the initial positions of 0.5, 1.0, 1.5 and 2.0 from the original edge are 0.417, 0.498, 0.519 and 0.554, respectively. Upon further breadth reduction to fractions of their post-drawn width of 0.939, 0.938, 0.906 and 0.875, the final TDDRs become 0.404, 0.467, 0.470 and 0.484, respectively. In this manner, the uniformity of the TDDR (and the thickness profiles) across the width substantially improve. Thus, the breadth reduction step allows the middle portion of the film to further neck down relative to the edge, allowing that middle portion to partially catch up with the neck down achieved by the edge during the previous drawing step.

### LO-Drawn Film:

TABLE 1
Example 2, Case 1

| posi- | | | | | | | |
|---|---|---|---|---|---|---|---|
| tion | relative | | | | | | relative |
| from | position | U | | | n (z) | | Bire- |
| edge | from | (initial | | | (aver- | delta n | frin- |
| (cm) | edge | draw) | n (x) | n (y) | age) | ny − nz | gence |
| 1.27 | 0.05 | 0.75 | 1.7689 | 1.5841 | 1.5714 | 0.0127 | 0.0664 |
| 2.54 | 0.11 | 0.57 | 1.7714 | 1.5850 | 1.5692 | 0.0158 | 0.0813 |
| 3.81 | 0.16 | 0.53 | 1.7753 | 1.5846 | 1.5666 | 0.0181 | 0.0904 |
| 5.08 | 0.21 | 0.47 | 1.7744 | 1.5862 | 1.5661 | 0.0201 | 0.1014 |
| 6.35 | 0.27 | 0.43 | 1.7726 | 1.5878 | 1.5656 | 0.0222 | 0.1133 |
| 7.62 | 0.32 | 0.39 | 1.7722 | 1.5894 | 1.5645 | 0.0249 | 0.1275 |
| 8.89 | 0.37 | 0.33 | 1.7728 | 1.5914 | 1.5633 | 0.0281 | 0.1438 |
| 10.16 | 0.43 | 0.27 | 1.7716 | 1.5921 | 1.5625 | 0.0296 | 0.1523 |
| 11.43 | 0.48 | 0.25 | 1.7716 | 1.5951 | 1.5624 | 0.0328 | 0.1698 |
| 12.70 | 0.53 | 0.23 | 1.7708 | 1.5935 | 1.5621 | 0.0314 | 0.1629 |
| 13.97 | 0.59 | 0.24 | 1.7707 | 1.5935 | 1.5619 | 0.0316 | 0.1637 |
| 15.24 | 0.64 | 0.24 | 1.7720 | 1.5935 | 1.5615 | 0.0320 | 0.1648 |
| 16.51 | 0.69 | 0.23 | 1.7717 | 1.5931 | 1.5622 | 0.0310 | 0.1595 |
| 17.78 | 0.75 | 0.22 | 1.7696 | 1.5938 | 1.5621 | 0.0317 | 0.1654 |
| 19.05 | 0.80 | 0.22 | 1.7698 | 1.5935 | 1.5619 | 0.0316 | 0.1645 |

### Unconstrained Heat Set

TABLE 2
Example 2, Case 2

| position | relative | | | | | | | | |
|---|---|---|---|---|---|---|---|---|---|
| from | position | U | | | | | | Change | Ratio |
| edge | from | (initial | | | n (z) | delta n | relative | relative | TDDR, final: |
| (cm) | edge | draw) | n (x) | n (y) | (average) | ny − nz | Birefringence | Birefringence | TDDR, Initial |
| 1.27 | 0.05 | 0.75 | 1.7856 | 1.5850 | 1.5717 | 0.0134 | 0.0644 | −0.002 | 0.969 |
| 2.54 | 0.11 | 0.57 | 1.7851 | 1.5875 | 1.5671 | 0.0204 | 0.0984 | 0.017 | 0.938 |
| 3.81 | 0.16 | 0.53 | 1.7805 | 1.5908 | 1.5658 | 0.0250 | 0.1236 | 0.033 | 0.906 |
| 5.08 | 0.21 | 0.47 | 1.7823 | 1.5935 | 1.5661 | 0.0274 | 0.1355 | 0.034 | 0.875 |
| 6.35 | 0.27 | 0.43 | 1.7875 | 1.5940 | 1.5653 | 0.0287 | 0.1381 | 0.025 | 0.875 |
| 7.62 | 0.32 | 0.39 | | 1.5940 | 1.5659 | 0.0281 | | | 0.844 |
| 8.89 | 0.37 | 0.33 | 1.7711 | 1.5915 | 1.5648 | 0.0267 | 0.1384 | −0.005 | 0.781 |
| 10.16 | 0.43 | 0.27 | | | | | | | |
| 11.43 | 0.48 | 0.25 | 1.7878 | 1.5961 | 1.5621 | 0.0341 | 0.1631 | −0.007 | 0.813 |
| 12.70 | 0.53 | 0.23 | 1.7826 | 1.5993 | 1.5603 | 0.0391 | 0.1925 | 0.030 | 0.828 |
| 13.97 | 0.59 | 0.24 | 1.7851 | 1.6017 | 1.5606 | 0.0411 | 0.2017 | 0.038 | 0.828 |
| 15.24 | 0.64 | 0.24 | 1.7865 | 1.6010 | 1.5592 | 0.0418 | 0.2025 | 0.038 | 0.844 |
| 16.51 | 0.69 | 0.23 | 1.7913 | | | | | | 0.828 |
| 17.78 | 0.75 | 0.22 | 1.7955 | 1.5989 | 1.5585 | 0.0404 | 0.1863 | 0.021 | 0.781 |
| 19.05 | 0.80 | 0.22 | 1.7951 | 1.5938 | 1.5600 | 0.0338 | 0.1549 | −0.010 | 0.719 |

### Unconstrained and Drawn During Heat Set

TABLE 3
Example 2, Case 3

| posi- | | | | | | | |
|---|---|---|---|---|---|---|---|
| tion | relative | | | | | relative | |
| from | position | U | | | n (z) | Bire- | |
| edge | from | (initial | | | (aver- | frin- | delta n |
| (cm) | edge | draw) | n (x) | n (y) | age) | gence | ny − nz |
| 1.27 | 0.05 | 0.75 | 1.8040 | 1.5848 | 1.5690 | 0.0698 | 0.0158 |
| 2.54 | 0.11 | 0.57 | 1.7980 | 1.5873 | 1.5663 | 0.0949 | 0.0210 |
| 3.81 | 0.16 | 0.53 | 1.7955 | 1.5889 | 1.5659 | 0.1055 | 0.0230 |
| 5.08 | 0.21 | 0.47 | 1.7976 | 1.5894 | 1.5646 | 0.1124 | 0.0248 |
| 6.35 | 0.27 | 0.43 | 1.7971 | 1.5905 | 1.5645 | 0.1184 | 0.0260 |
| 7.62 | 0.32 | 0.39 | 1.8017 | 1.5885 | 1.5621 | 0.1166 | 0.0264 |
| 8.89 | 0.37 | 0.33 | 1.8046 | 1.5862 | 1.5631 | 0.1007 | 0.0232 |
| 10.16 | 0.43 | 0.27 | | | | | |
| 11.43 | 0.48 | 0.25 | 1.7878 | 1.5889 | 1.5621 | 0.1265 | 0.0268 |
| 12.70 | 0.53 | 0.23 | 1.7855 | 1.5929 | 1.5608 | 0.1538 | 0.0321 |
| 13.97 | 0.59 | 0.24 | 1.7935 | 1.5963 | 1.5592 | 0.1720 | 0.0371 |
| 15.24 | 0.64 | 0.24 | 1.7928 | 1.5995 | 1.5591 | 0.1892 | 0.0404 |
| 16.51 | 0.69 | 0.23 | 1.7945 | 1.5970 | 1.5593 | 0.1743 | 0.0377 |
| 17.78 | 0.75 | 0.22 | 1.7958 | 1.5940 | 1.5598 | 0.1562 | 0.0342 |
| 19.05 | 0.80 | 0.22 | 1.7928 | 1.5896 | 1.5627 | 0.1242 | 0.0269 |

### Constrained Heat Set

TABLE 4
Example 2, Case 4

| position | | | | | |
|---|---|---|---|---|---|
| from edge | U (initial | | | n(z) | delta n |
| (cm) | draw) | n(x) | n(y) | (average) | ny − nz |
| 1.27 | 0.75 | 1.7939 | 1.5951 | 1.5665 | 0.0286 |
| 2.54 | 0.57 | 1.7928 | 1.5991 | 1.5665 | 0.0326 |
| 3.81 | 0.53 | 1.7987 | 1.5991 | 1.5559 | 0.0432 |
| 5.08 | 0.47 | 1.7941 | 1.6012 | 1.5578 | 0.0435 |
| 6.35 | 0.43 | 1.7837 | 1.6031 | 1.5606 | 0.0425 |
| 7.62 | 0.39 | 1.7873 | 1.6049 | 1.5582 | 0.0467 |
| 8.89 | 0.33 | 1.7980 | 1.6054 | 1.5515 | 0.0539 |
| 10.16 | 0.27 | 1.7961 | 1.6047 | 1.5520 | 0.0527 |
| 11.43 | 0.25 | 1.8011 | 1.6024 | 1.5474 | 0.0550 |
| 12.70 | 0.23 | 1.7934 | 1.6107 | 1.5472 | 0.0635 |
| 13.97 | 0.24 | 1.7928 | 1.6129 | 1.5447 | 0.0683 |
| 15.24 | 0.24 | 1.7995 | 1.6152 | 1.5440 | 0.0713 |
| 16.51 | 0.23 | 1.7903 | 1.6138 | 1.5473 | 0.0665 |
| 17.78 | 0.22 | 1.7897 | 1.6129 | 1.5474 | 0.0655 |
| 19.05 | 0.22 | 1.7908 | 1.6142 | 1.5469 | 0.0674 |

### Constrained and Drawn During Heat Set

TABLE 5
Example 2, Case 5

| position | relative | | | | | |
|---|---|---|---|---|---|---|
| from | position | U | | | | |
| edge | from | (initial | | | n (z) | delta n |
| (cm) | edge | draw) | n (x) | n (y) | (average) | ny − nz |
| 1.27 | 0.05 | 0.75 | 1.8074 | 1.5956 | 1.5506 | 0.0451 |
| 2.54 | 0.11 | 0.57 | 1.8040 | 1.5975 | 1.5534 | 0.0441 |
| 3.81 | 0.16 | 0.53 | 1.8006 | 1.5984 | 1.5534 | 0.0450 |
| 5.08 | 0.21 | 0.47 | 1.7961 | 1.6012 | 1.5549 | 0.0463 |
| 6.35 | 0.27 | 0.43 | 1.8016 | 1.6023 | 1.5495 | 0.0529 |
| 7.62 | 0.32 | 0.39 | 1.8024 | 1.6035 | 1.5478 | 0.0557 |
| 8.89 | 0.37 | 0.33 | 1.7981 | 1.6042 | 1.5488 | 0.0555 |
| 10.16 | 0.43 | 0.27 | 1.7996 | 1.6037 | 1.5492 | 0.0545 |
| 11.43 | 0.48 | 0.25 | 1.8129 | 1.6005 | 1.5446 | 0.0559 |
| 12.70 | 0.53 | 0.23 | 1.7919 | 1.6091 | 1.5499 | 0.0593 |
| 13.97 | 0.59 | 0.24 | 1.7925 | 1.6122 | 1.5474 | 0.0648 |
| 15.24 | 0.64 | 0.24 | 1.7925 | 1.6126 | 1.5463 | 0.0663 |
| 16.51 | 0.69 | 0.23 | 1.7942 | 1.6129 | 1.5452 | 0.0677 |
| 17.78 | 0.75 | 0.22 | 1.7955 | 1.6122 | 1.5447 | 0.0675 |
| 19.05 | 0.80 | 0.22 | 1.7938 | 1.6138 | 1.5452 | 0.0686 |

### Example 3

### Modeling Procedures

Modeling data, such as for the discussion relating to FIGS. 6-12, for example, were obtained from the finite element method (FEM), using the general-purpose finite element analysis (FEA) program ABAQUS™, a product of ABAQUS, Inc. of Providence, R.I. The finite element method is a numerical technique for solving partial differential equations. Any commercial or proprietary FEA program capable of handling geometric, material, and contact nonlinearities could be used to develop similar models. Examples of alternative commercial programs include ANSYS®, a product of ANSYS, Inc. of Canonsburg, Pa.; and MARC™, a product of MSC Software Corporation of Santa Ana, Calif.

For a typical draw gap scenario, the model consisted of the driven inlet roll 102/Dᵢ, the driven outlet roll 106/Dₒ, and the polymer web 20. Dimensional parameters included the diameters of the inlet and outlet rolls (φᵢ and φₒ, respectively), the distance separating the axes of the two rolls (L), and the wrap angle of the web over the inlet and outlet rolls (θᵢ and θₒ, respectively). In the embodiment shown in FIG. 3C, the wrap angle of the web over the inlet and outlet rolls is about 135°. In the embodiment shown in FIG. 3D, the wrap angle of the web over the inlet and outlet rolls is about 90°. In addition, the initial width of the web (Wᵢ), and the initial cross-web thickness profile of the web (tᵢ(x)) were specified. A half-symmetric model was used.

The inlet and outlet rolls were assumed to be driven at the constant rotational speeds ωᵢ and ωₒ, respectively. The ratio of the inlet to outlet rotational speeds defines the draw ratio. To maintain web tension, the web speed prior to the inlet roll (vᵢ) was assumed to be equal to or just slightly less than the surface velocity of the inlet roll (½φᵢωᵢ). Likewise, the web speed following the outlet roll (vₒ) was assumed to be equal to or slightly greater than the surface velocity of the outlet roll (½φₒωₒ).

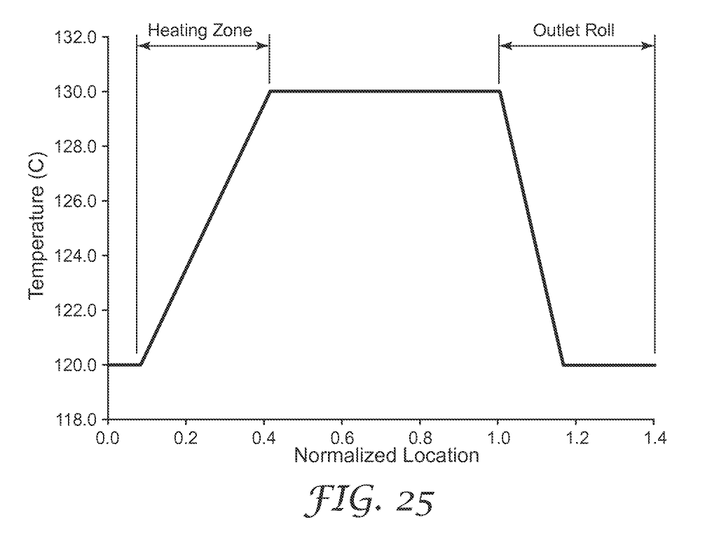

The incoming web was assumed to be at an initial temperature Tᵢ. A representative temperature profile is illustrated in FIG. 25. The web temperature was assumed to increase linearly from Tᵢ to Tₕ while in the heating zone which starts at a distance L from the inlet roll, and continues for the distance Lₕ. The web temperature then remained constant at Tₕ until contacting the outlet roll. The web temperature was then assumed to decrease linearly from Tₕ to Tₒ during the time it was in contact with the cooled outlet roll. The temperature was then held constant at Tₒ.

The web material, for example polyethylene, was modeled using a temperature-dependent, finite strain viscoelastic constitutive model. In particular, a neo-Hookean hyperelasticity model was combined with a Prony series representation of a Maxwell viscoelastic model and the Williams-Landell-Ferry time-temperature shift function. This model accounted for the strain-rate dependencies and temperature-dependencies observed during stretching of polymer films at elevated temperatures. Material constants were derived from fitting to experimental uniaxial and biaxial tension data.

Finite strain shell elements were used to model the web. These elements are capable of representing both the in-plane membrane stiffness of the web, as well as out-of-plane thickness response. The inlet and outlet rolls were modeled as analytical rigid surfaces. Frictional contact between the web and roll surface was modeled using a classical Coulomb friction model. Typically, a value of 0.2 was assumed for the coefficient of friction. A quasi-static solution procedure was used.

For structural mechanics, the relevant equations are derived from the conservation of mass and momentum. The momentum equation, which defines the dynamic state of equilibrium, can be expressed using indicial notation as

$$\frac{\partial {σ}_{ij}}{\partial {x}_{j}} + ρ {B}_{i} = \partial \frac{{\partial }^{2} {u}_{i}}{\partial {t}^{2}}$$

where

σᵢⱼ are the components of the stress tensor,

xᵢ are the components of an orthonormal basis,

ρ is the local mass density,

Bᵢ are the components of the body force vector,

uₜ are the components of the displacement vector, and

t is time.

The continuity equation, which describes the conservation of mass, can be written as

$$\frac{\partial ρ}{\partial t} + \frac{\partial }{\partial {x}_{i}} ( ρ \frac{\partial {u}_{i}}{\partial t} ) = 0$$

The momentum equation defines the point-wise balance between internal reaction forces, externally applied loads, and inertial forces. The continuity equation defines the point-wise relationship between the rate of change of the mass density and the divergence of the mass flow rate.

Alternative modeling assumptions could be adopted for simulation of a length orientation process. For example, an elastic-plastic, viscoplastic, or other constitutive model might be used to represent the behavior of the polymer being evaluated. An alternative solution procedure (e.g., dynamic), element formulation (e.g., membrane), or friction model might also be used. Some scenarios may require the use of a complete (i.e., non-symmetric) model, or require simulation of a non-driven (i.e., free-spinning) roll. Finally, alternative temperature profiles could be assumed, or a fully or partially coupled thermal-structural analysis procedure could be used.

### Example 4

### Neckdown Reversal

A cast web (amorphous film) of polyethylene terephthalate with an IV of about 0.60 dL/g was cast to about 1 millimeter thick, fed into an L.O. pre-heat roller stack and pre-heated to about 80 degrees Celsius. The heated film was further heated above its glass transition temperature using an infra-red heating system as it was drawn over 5 seconds across a gap between slower and faster rotating rolls. To account for thermal expansion with heating, the slow inlet roll into the draw gap was run about 0.5% faster than the inlet roller into the pre-heat zone. Likewise, during quenching, the final outlet quench roll was run about 0.7% slower than the final speed of the fast outlet roll from the draw gap.

In a first casting condition, two films were heated to over 95 degrees C. in the gap and drawn under nearly identical conditions to MD draw ratios of 3.5 and 4.5. These resulted in neckdowns of 14.2% and 12.4% respectively. Thus, the phenomenon of neckdown reversal upon increasing MDDR was demonstrated with these examples.

In a second casting condition, three films were heated to over 95 degrees C. in the gap and drawn under nearly identical conditions to MD draw ratios of 3.25, 3.65 and 4.05. These resulted in neckdowns of 13.6%, 14.1% and 12.4% respectively. Thus, the phenomenon of neckdown reversal upon increasing MDDR was again demonstrated with these examples.

The first set of conditions was accomplished at a higher lamp power than the second, so presumably the additional heating created a slightly longer effective draw gap, thus resulting in the higher neckdown at the lower MDDR setting. It follows that in the second set of conditions, the higher MDDR setting was required to achieve the same level of neckdown reversal.

It follows that a multilayer optical cast web, for example one comprising a polyester and an acrylic polymer (e.g. PET, coPEN or PEN paired with PMMA or coPMMA in alternating layers) could be extruded in accord with the method of U.S. Pat. No. 6,830,713 and then similarly stretched with neckdown reversal under similar levels of MDDR.

### Example 5

The cast web precursor of Example 2 was drawn in a laboratory stretcher at 115 degrees C. over 10 seconds to a draw ratio of about 4.5, and under L/W conditions between 0.5 and 1.0. The film necked down to about 0.65 its initial width. The refractive indices in the 90/10 coPEN outer layer were measured at 632.8 nm (using a Metricon prism coupler available from Metricon of Piscataway, N.J., USA) to be 1.826, 1.575 and 1.549 along the draw, cross-draw and thickness directions, respectively. The center of the film was further cut into a narrow strip with L/W of about 10, and heat set under length constraint with free edges at 170 degrees C. over 2 minutes. The final indices were 1.848, 1.588 and 1.534. The film demonstrated little additional breadth reduction upon drawing, demonstrating a condition of orientation over the critical index for breadth reduction prior to a subsequent heat setting step.

In a second experiment, the same cast web was similarly drawn, this time with edge constraint, to a draw ratio of 4.3. The final width was at least 95% of the original width. The refractive indices were measured to be 1.816, 1.597 and 1.538 along the draw, cross-draw and thickness directions, respectively. The center of the film was further cut into a narrow strip with L/W of about 10, and heat set under length constraint with free edges at 170 degrees C. over 2 minutes. The final indices were 1.838, 1.618 and 1.513. Again, the film demonstrated little additional breadth reduction upon drawing, demonstrating a condition of orientation over the critical index for breadth reduction prior to a subsequent heat setting step.

In a third experiment, the same cast web was again drawn, this time with edge constraint, to a nominal draw ratio of only about 3.0. The final width was at least 95% of its original width. The refractive indices were measured to be approximately 1.773, 1.593 and 1.568 along the draw, cross-draw and thickness directions, respectively. The relative birefringence was thus about 0.133. Because of the low draw ratio and laboratory stretcher configuration, the draw was not as uniform along the length of the sample as obtained in the roll of Case 1 of Example 2. The center of the film was further cut into a narrow strip with L/W of about 10, and heat set under length constraint with free edges at 170 degrees C. over 2 minutes. The film reduced in breadth to about 70% of its post-drawn width. Two locations on the final breadth reduced film were measured. In the first location with a slightly higher than nominal draw ratio, the final indices were 1.8047, 1.594 and 1.560 with a relative birefringence of 0.151. In the second location, with slighter lower than nominal draw ratio, the final indices were measured to be 1.7925, 1.5871 and 1.571. The relative birefringence in this case decreased to a value of 0.076. Thus, the relative birefringence changes again appear to depend upon both the initial state of uniaxial character U, as well as the breadth reduction.

All patents, patent applications, provisional applications, and publications referred to or cited herein are incorporated by reference in their entirety, including all figures and tables, to the extent they are not inconsistent with the explicit teachings of this specification.

It should be understood that the examples and embodiments described herein are for illustrative purposes only and that various modifications or changes in light thereof will be suggested to persons skilled in the art and are to be included within the spirit and purview of this application.

What is claimed is:

1. A method of increasing a uniaxial orientation of an optical film comprising:
providing a drawn film having an initial breadth dimension and direction;
constraining the drawn film in a direction substantially perpendicular to the breadth direction while not constraining the drawn film in the breadth direction; and
heating the drawn film above a glass transition temperature of at least one component thereof to allow for a reduction of the initial breadth.

2. The method of claim 1, wherein the step of providing a drawn film includes drawing the film in the direction substantially perpendicular to the breadth direction.

3. The method of claim 2, wherein the step of drawing the film includes maintaining or decreasing a breadth dimension of the film.

4. The method of claim 2, wherein the step of drawing the film includes drawing at a draw ratio of about 4 or less.
